(19) United States
(12) Patent Application Publication
(10) Pub. No.: US 2019/0044738 A1
(43) Pub. Date: Feb. 7, 2019

(54) MOBILE DEVICE CERTIFICATE DISTRIBUTION

(71) Applicant: Intel Corporation, Santa Clara, CA (US)

(72) Inventors: Xiruo Liu, Portland, OR (US); Liuyang Yang, Portland, OR (US); Manoj R. Sastry, Portland, OR (US); Moreno Ambrosin, Hillsboro, OR (US)

(21) Appl. No.: 15/971,314

(22) Filed: May 4, 2018

(51) Int. Cl. H04L 9/32; H04W 4/40

(52) U.S. Cl. CPC H04L 9/3265; H04W 4/40; H04L 9/3268

(57) ABSTRACT

Disclosed herein are mobile device distribution methods and apparatuses. In embodiments, a system for managing cryptographic exchanges between devices capable of operating in accord with the Wireless Access Vehicular Environment (WAVE) functionality may comprise a device operable in at least a first environment in which the device is configured to: receive a first message with an associated first certificate chain; and add a second certificate chain associated with the device to a second message. The device may further determine if the first certificate chain includes an unknown certificate, and if so, set a flag associated with the second message; as well as determine if all certificates in the first certificate chain are known, and if so, check if message has the set flag, and if the flag is set, then unset the flag; and send the second message. Other embodiments may be disclosed and claimed.

### TECHNICAL FIELD

The present disclosure relates to cryptographic certificate exchanges, and more particularly to improve the robustness for safety systems with efficient certificate exchanges.

### BACKGROUND AND DESCRIPTION OF RELATED ART

The United States Department of Transportation is working on federal motor vehicle safety standards related to vehicle-to-everything (V2X) technology called Dedicated Short-Range Communications (DSRC). The IEEE has developed various standards relating to V2X communications. V2X concerns exchanging information between entities in vehicular environments, such as between vehicles, Road Side Units (RSUs), other infrastructure, pedestrians, etc. V2X complements onboard sensors (OBS) used for semi-autonomous and autonomous driving, enabling cars to better understand its surrounding environment beyond the immediate range of onboard sensors such as radar, Lidar and camera etc. An example V2V based collision avoidance, where vehicles exchange Basic Safety Messages (BSMs) every 100 ms to communicate critical driving status, e.g., the current position, yaw rate, speed and acceleration of the vehicle, based on which intelligent predictions can be made to alert the drivers of the danger if imminent crash is foreseen.

DSRC is also known as the IEEE Wireless Access in Vehicular Environments (WAVE), which includes the IEEE 802.11p and IEEE 1609 series of standards for vehicular communications. In particular, IEEE 1609.2 standard defines security services for applications and management messages. IEEE 1609.2 relies on certificates and the public key infrastructure to establish trust for vehicular communications. Digital signatures are used to provide message integrity; the message receiver can use the signing certificate, and its associated certificate chain, to validate the signature. The authenticity and integrity of a message may be validated through the signature with multiple certificates, represented by a certificate chain, where the signing certificate is validated by a certificate from a more senior authority, which in turn may be authenticated by a more senior authority, etc., going back to a root authority, e.g., a root Certificate Authority (CA) known to be trusted. If all verifications succeed, then the message is deemed trustable.

However, to improve communication efficiency, IEEE 1609.2 does not mandate inclusion of the whole certificate chain inside signed messages. A signed message might only carry the signing certificate, or a partial certificate chain. The dynamic nature of V2X scenarios, the focus on reducing latency for safety critical applications and reducing the overhead introduced to the communication channels, and the potentially large space of Certificate Authorities (CAs) and their certificates that may be used, makes certificate distribution particularly challenging in V2X. Therefore, given these certificate distribution concerns, and since latency may increase risk, a receiver of a signed message might be unable to immediately re-construct the complete certificate chain associated to the signed message; reduced latency is prioritized over complete authentication.

IEEE 1609.2 in part addresses certificate reconstruction, especially at the V2V level, and defines the Peer-to-Peer Certificate Distribution (P2PCD) protocol. P2PCD allows a receiver unable to validate a signature due to not recognizing the issuer of the topmost certificate provided within the signed message, to request missing certificates from local peers, e.g., by broadcasting Certificate Learning Request (CLR) to vehicles in transmission range. Responders, who receive the CLR, may broadcast back a relevant certificate, if they have it.

Unfortunately, any vehicles, including unauthenticated/malicious ones, can launch this P2PCD procedure. Therefore, P2PCD protocol may bring vulnerability for a Denial of Service (DoS) attack on the V2V network's availability. On the other hand, mitigating DoS by reducing the frequency of P2PCD executions (e.g., set large values for time out parameters defined in P2PCD protocol) may increase the latency for signature verification, and hence impact the V2V service availability. Moreover, with a pure ad hoc fashion, the success of obtaining the requested certificate from local neighboring vehicles cannot be guaranteed.

One reason for P2PCD was to increase messaging efficiency to improve safety-critical applications, such as collision avoidance, hence the vulnerability and inefficiency may reduce safety. While this attack problem may be mitigated in part by providing certificates to receivers through an out-of-band channel, e.g., proactively by pre-installing CA certificates inside the vehicle to anticipate future needs, this solution may be impractical. Worldwide, there may be too many CAs, and CA certificates, that may be accommodated in a vehicle. And while a regional approach to CA pre-installation may be used to minimize the burden, vehicles are by definition mobile and as they travel they may come in contact with many vehicles from other regions/countries, and need to resolve missing certificates. Also, certificates have a lifecycle and eventually need to be renewed/updated, making pre-installment impractical; safe dynamic distribution is needed.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates an exemplary environment 100 illustrating a receiver vehicle receiving a message with an incomplete certificate chain.

FIG. 2 illustrates an exemplary environment 200 showing infrastructureless and infrastructure certificate distribution.

FIG. 3 illustrates an exemplary environment 300 illustrating the format of a certificate defined by IEEE 1609.2 (2016 version).

FIG. 4 illustrates an exemplary environment 400 illustrating RSU message monitoring and database update.

FIG. 5 illustrates an exemplary environment 500 for infrastructured certificate distribution according to one embodiment.

FIG. 6 illustrates an exemplary environment 600 illustrating adjusting RSU message dissemination frequency.

FIG. 7 illustrates an exemplary environment 700 from the perspective of a vehicle or other device operating in infrastructured or infrastructureless mode.

FIG. 8 illustrates an exemplary computer device that may employ the apparatuses and/or methods described herein.

FIG. 9 illustrates an exemplary computer-accessible storage medium.

FIG. 10 illustrates a block diagram of a network illustrating communications among a number of IoT devices, according to an example; and

FIG. 11 illustrates a block diagram for an example IoT processing system architecture upon which any one or more of the techniques (e.g., operations, processes, methods, and methodologies) discussed herein may be performed, according to an example.

FIG. 12 illustrates a block diagram of a network illustrating communications among a number of IoT devices, according to an example.

FIG. 13 illustrates a block diagram for an example IoT processing system architecture upon which any one or more of the techniques (e.g., operations, processes, methods, and methodologies) discussed herein may be performed, according to an example.

### DETAILED DESCRIPTION

In the following detailed description, reference is made to the accompanying drawings that form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents. Alternate embodiments of the present disclosure and their equivalents may be devised without parting from the spirit or scope of the present disclosure. It should be noted that like elements disclosed below are indicated by like reference numbers in the drawings.

Various operations may be described as multiple discrete actions or operations in turn, in a manner that is most helpful in understanding the claimed subject matter. However, the order of description should not be construed as to imply that these operations are necessarily order dependent. In particular, these operations do not have to be performed in the order of presentation. Operations described may be performed in a different order than the described embodiment. Various additional operations may be performed and/or described operations may be omitted in additional embodiments. For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C). The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are considered synonymous.

Illustrated embodiments disclose various techniques for dynamically distributing certificates while being resistant to attacks. Disclosed embodiments and discussed certificate sharing solutions may be applied in both “infrastructured” (communication in conjunction with a Road Side (or RoadSide) Unit (RSU) type of device), as well as “infrastructureless” mode, e.g., vehicle to vehicle communication. In various embodiments, a RSU is used, when available, to handle certificate provisioning within a neighborhood or other specific location; and when a RSU is not available, then certificate provisioning may be performed at the Vehicle-to-Vehicle (V2V) level, e.g., out of wireless range, not configured for communication with a vehicle, or otherwise unavailable. It will be appreciated while this document may refer to a RSU, the RSU is used for exemplary purposes as it aligns with disclosed exemplary vehicle provisioning environments. It will be understood by one skilled in the art that other machines, devices, systems, etc. may provide some or all of the services discussed herein for a RSU and that this disclosure is intended to include these other machines, devices, etc. and they may provision and/or communicate with any other device, including the vehicles discussed herein, but may also be used to communicate with other mobile devices and/or technology. The RSUs and vehicles are therefore understood to be presented as exemplary embodiments. In various embodiments, Internet of Things (IoT) are used. IoT a concept in which a large number of computing devices are interconnected to each other and to the Internet to provide functionality and data acquisition at very low levels. Thus, as used herein, an IoT device may include a semiautonomous device performing a function, such as sensing or control, among others, in communication with other IoT devices and a wider network, such as the Interne

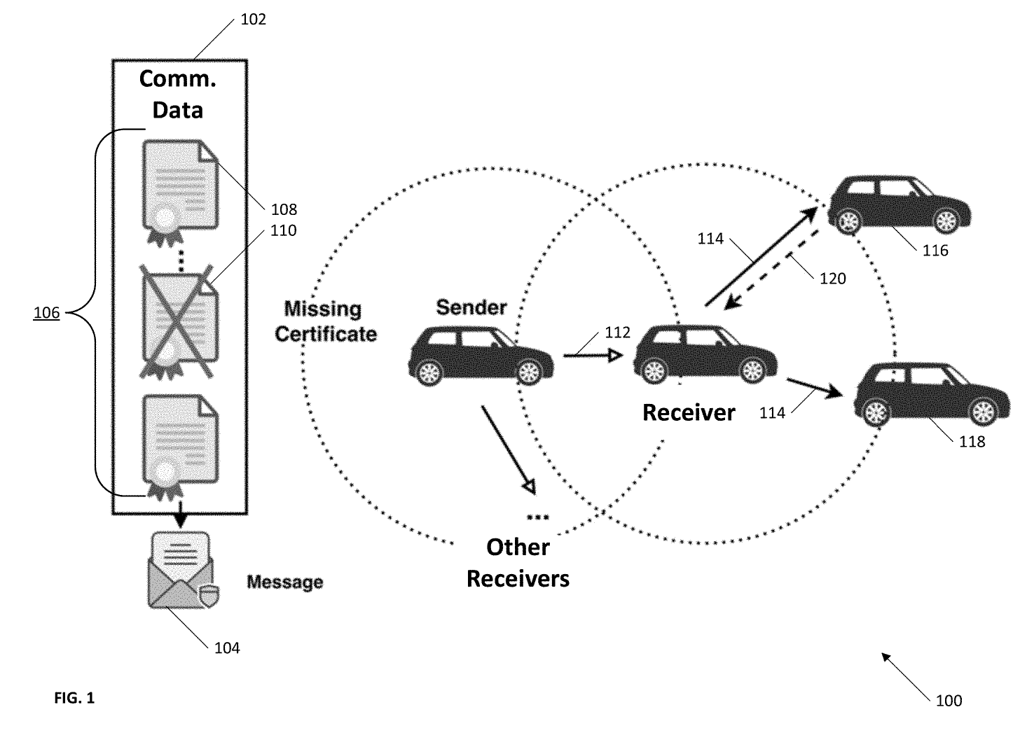

FIG. 1 illustrates an exemplary environment 100 illustrating a receiver vehicle receiving a message with an incomplete certificate chain in communication data 102. The data contains a certificate chain and/or other data associated with a received message 104. Typically a received message is cryptographically certified with a chain of certificates 106 each certificate applied to a message as it is handed off, where each certificate used has an authenticity based on another certificate authority (CA), until a root CA 108 is reached in the chain. Chained authentication allows a message to travel through multiple entities or devices before received by a recipient where the recipient can validate the received message is legitimate. However as noted above, IEEE 1609.2 does not require a complete chain, it only requires that at least one certificate be known and trusted by a receiver. There may be one or more missing certificate(s) 110 in SPDU (Secured Protocol Data Unit)

For retrieving missing certificates, the P2PCD allows the receiver of a signed message to reactively request and fetch the missing certificate from its local neighboring vehicles. As illustrated, a sender may send a message 112 that is missing one or more certificate, and the receiver may in turn, as allowed by IEEE 1609.2 P2PCD procedure, send a Certificate Learning Request (CLR) request 114 to nearby vehicles 116, 118 to see if they have the missing certificate(s). Receivers that have the missing certificate, e.g., vehicle 116, may send 120 the requested certificate back responsive to the CLR.

As will be discussed in further detail below, in infrastructured mode, an RSU may proactively provision a vehicle or other mobile device with “potentially missing” CA certificates associated with a neighborhood, including intermediate CA certificates, root CA certificates as well as elector certificates and endorsements. The term “neighborhood” is intended to generally represent both a geographic region, e.g., vehicles or other machines in a particular area, as well as vehicles or machines that are in and/or expected to be in the neighborhood. Thus vehicles in a neighborhood would be provisioned, as well as delivery and/or other vehicles that are known to pass through the neighborhood. In addition, certain conditions, such as an active map route of a navigation function, e.g., such as a vehicle's navigation system, may be used to identify neighborhoods the vehicle is likely to contact and hence when in communication range of a RSU the vehicle may be provisioned with certificates for its current neighborhood as well as for the neighborhoods associated with the vehicle's navigation route. In some embodiments, certificate distribution frequency may be adjusted based on contextual parameters to reduce the communication overhead associated with certificate provisioning.

As will be discussed in further detail below, in infrastructureless mode, a reactive process will be discussed to exchange full certificate chains among authenticated neighboring vehicles. This will limit ability of illegitimate vehicles triggering the P2PCD process. In combination the infrastructured and infrastructureless modes to efficiently and robustly support environments such as WAVE/DSRC with dynamic certificate distribution.

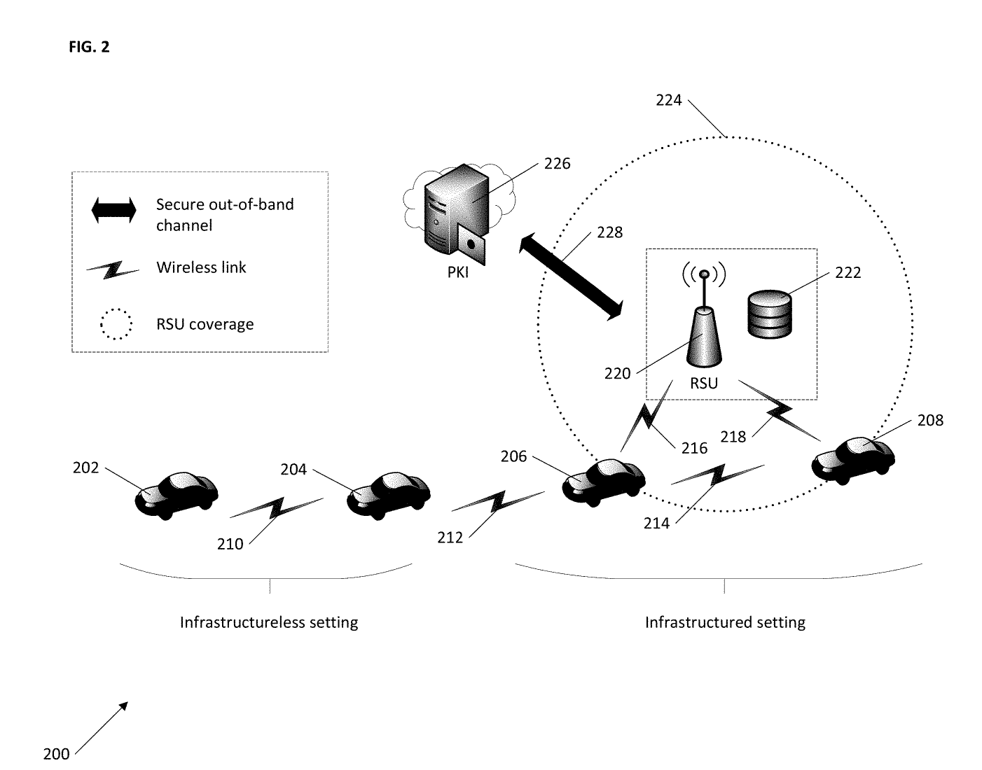

FIG. 2 illustrates an exemplary environment 200 showing infrastructureless and infrastructure certificate distribution. As illustrated there are multiple vehicles 202-208 that have embedded and/or associated (by way of a portable device such as a cell phone or other device) transceivers of some type or types that allow the vehicles to communicate 210-218 to manage certificates. It will be appreciated that there may be multiple radios and or conductive communication mediums, e.g., to allow for roadway inductive communication. Communication 210-218 may be in accord with the IEEE 1602 family of standards and/or in compliance with other standards and/or proprietary or non-proprietary protocols. There may also be one or more Road Side Units (RSU) 220 which may be stationary, e.g., deployed along a road, installed within intersections, or in/on/adjacent to a building, etc. It will be appreciated the RSU may be mobile, e.g., installed in a vehicle, drone, or other mobile platform, and be tasked with assisting in areas that may be needing services. For example, traffic movement may be monitored and if an uptick in traffic or other change is detected in a neighborhood, a mobile RSU may be deployed to assist in that neighborhood and further review may be performed to determine whether to keep the RSU in that neighborhood.

It will be appreciated the RSU will have a wired and/or wireless communication pathway to one or more Public Key Infrastructure (PKI) 224 server, which serves certificates for vehicle communications. In one embodiment the PKI operates in a manner similar to the deployment and design assumption with DSRC/WAVE. It will be appreciated security for DSRC-based vehicular communications is defined by IEEE 1609.2, and is based on digital signatures on messages, and certificates. Signed messages in IEEE 1609.2 include four parts: header, payload, signature, and signing certificate. For more information, see, e.g., Li, Yunxin (Jeff). (2012). “An overview of the DSRC/WAVE technology” at Internet Uniform Resource Locator (URL) v2x.ir/Admin/Files/eventAttachments/An%20Overview%20of%20the%20DSRCWAVE%20Technology -Yunxin%20Li_172.pdf. In one embodiment the PKI exposes a set of APIs that may be queried by an entity to fetch certificates, through communication pathway 228 or other pathway (not illustrated), which may represent communication occurring over the Internet or other network. Each RSU may maintain a local database (DB) 222 of certificates and associated certificate chains.

As used herein the term “infrastructured” refers to the vehicles 206, 208 that are within the wireless coverage area 224 of the RSU 220, and are thus able to receive messages from the RSU. As used herein the term “infrastructureless” refers to vehicles 202, 204 that are currently outside of any RSU coverage (or the RSU is operating as a passive device, such as simply monitoring its environment instead of actively communicating with vehicles and/or other devices in its coverage area). If not in communication with the RSU or equivalent/other device providing RSU-type services, vehicles 202, 204 may communicate at the Vehicle-to-Vehicle (V2V) level. It will be appreciated that communication does not need to be either communicate with the RSU or communicate with other vehicles. Rather, a vehicle 206 may be both in range of the RSU, while also in range of another vehicle 204 that is outside the RSU coverage area. In one embodiment, the in-range vehicle may operate as a conduit to proxy a connection between the out of range vehicle 204 and the RSU. In another embodiment, the in-range vehicle 206 may instead receive a Certificate Learning Request from an out of range vehicle 204, and in turn make an equivalent request of the RSU. The RSU will provide the certificate to the in-range vehicle 206 which may then respond to the CLR with the information obtained from the RSU. This allows a vehicle ordinarily unable to respond to a CLR to be able to respond by way of information requested from the RSU.

In one embodiment, a RSU 220 may contain all known certificates and associated certificate chains, e.g. all that are known to the PKI 226. In another embodiment, the RSU has a partial certificate store and may only contain certificates and associated certificate chains for vehicles known to its neighborhood, as well as for vehicles expected to be entering the neighborhood based on various information such as trajectory analysis, active in-vehicle navigation, etc. In one embodiment, the PKI is communicatively coupled with the RSU over a communication pathway 228, such as a secure out-of-band channel between the RSU and PKI. It will be appreciated that the pathway 228 may be any combination of private network and/or public network, e.g., communication may be by way of a secure tunnel through the Internet. When the RSU sees certificate needs from vehicles 206, 208, the RSU may provide data if currently stored by the RSU, e.g., in its database 222, or it may request needed data from the PKI and then respond to the vehicles.

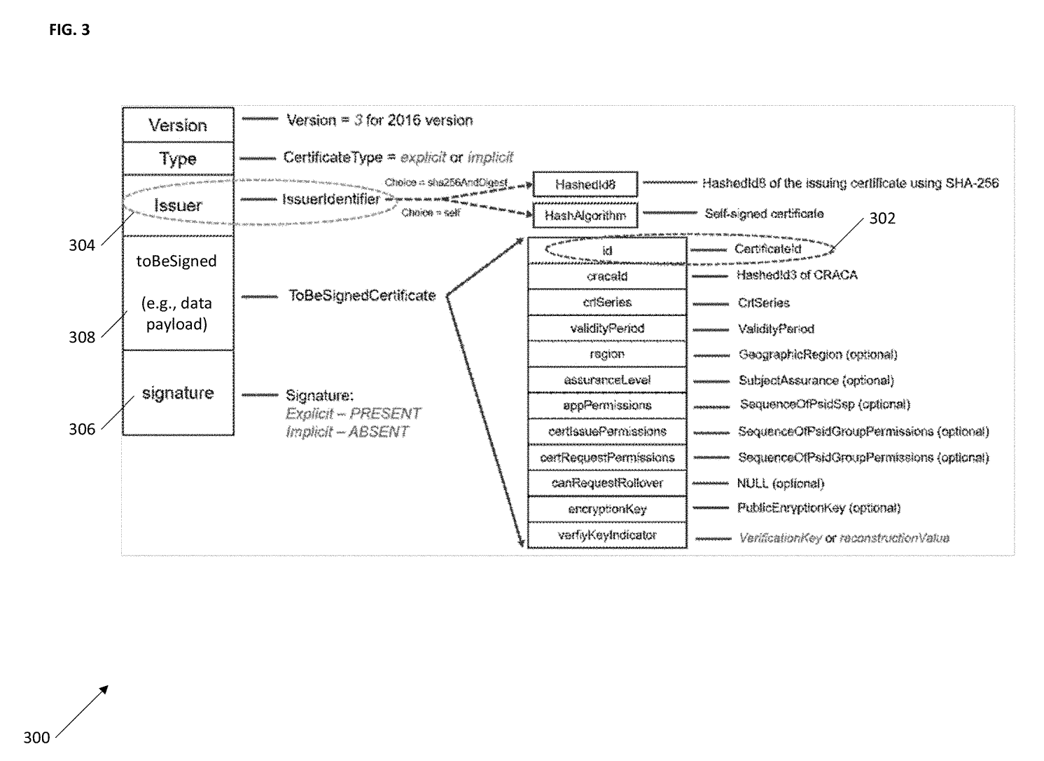

FIG. 3 illustrates an exemplary environment 300 illustrating the format of a certificate. As illustrated a standard IEEE 1609.2 (2016) certificate has a variety of fields defining the format of a certificate. It will be appreciated that this certificate format is presented for exemplary purposes only and that other certificate systems or other security/secure-communication/validated-communication environments may be used to implement the disclosed embodiments. Certificates include an “id” field 302 which (uniquely) identifies it, and an Issuer 304 field, which is a pointer to a parent certificate in a certificate chain.

As discussed above, certificates may be linked in a chain, e.g., FIG. 1 item 106, that eventually leads to a root certificate, e.g., FIG. 1 item, 108, where the root certificate would, in the illustrated embodiment, contain an issuer pointer pointing to itself. In one embodiment the issuer field pointer contains a truncated hash of the issuing certificate that enables looking up the issuer. It will be appreciated the pointer may contain other data or be a function of data associated with the issuing certificate. In the illustrated embodiment, a certificate is signed by the issuing certificate to enable a secure trust chain verification. In one embodiment a private key associated with the issuer is used to sign the toBeSigned field 308.

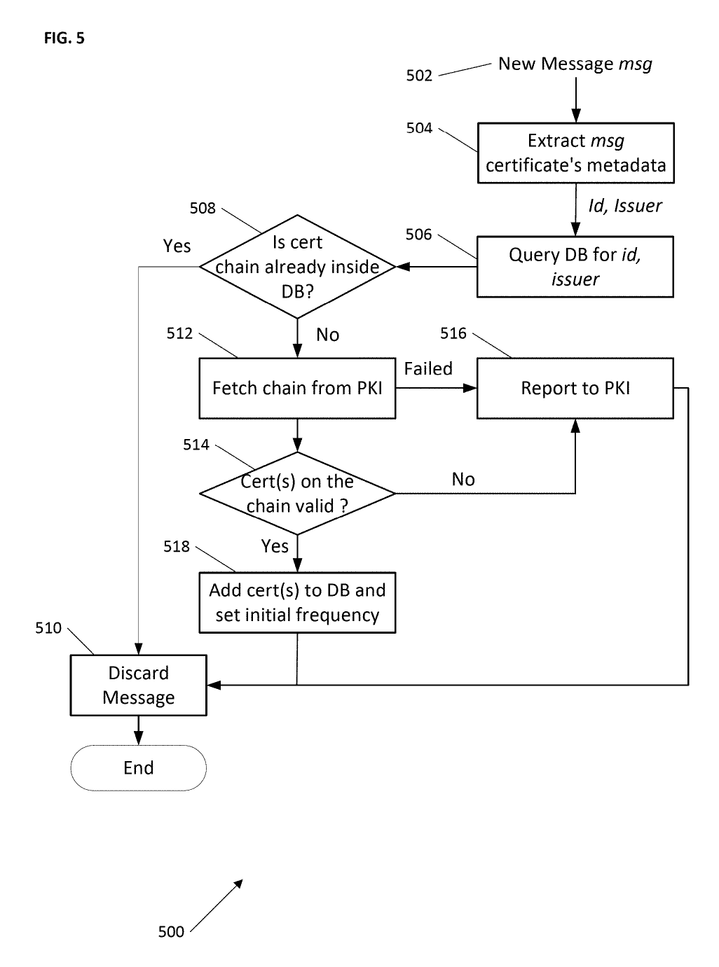

As discussed above, it is assumed impractical to preload a vehicle with all possible CA certificates with which the vehicle may come into contact. Therefore, in one embodiment, a proactive approach is taken for certificate distribution. For example, certificates may be distributed only when their use is anticipated within a neighborhood of communicating vehicles or other defined collection of communicatively coupled devices and/or vehicles. In the context of being in range of a RSU (infrastructured), as discussed in more detail with respect to FIG. 5, a certificate distribution mechanism may be used which relies on the RSU to monitor activity in its neighborhood and determine when to distribute “new” certificates to vehicles in the RSU's coverage area. The RSU may determine need to distribute a certificate based on a variety of metrics, some of which are discussed further below with respect to the FIG. 6 embodiment. In the context of being out of range of a RSU or other device that may provide certificate data, in one embodiment Vehicle-to-Vehicle (V2V) communication may be used (infrastructureless) for certificate distribution. For example, a receiver of a signed message, which is unable to verify this message due to missing part of the certificate chain, may provide its complete certificate chain first and signal the sender to respond with its complete certificate chain reciprocally. In another embodiment, a hybrid certificate distribution mechanism may be used when, for example, a vehicle is both in an infrastructured as well as infrastructureless communications, e.g., FIG. 2 vehicle 206 may communicate with the RSU and also communicate with vehicles outside the RSU's coverage area. When available, infrastructured certificate distribution is used. If unavailable, then a hybrid approach, if available, may be used to gain indirect access to the RSU. If the hybrid approach is also unavailable, and vehicles are out of the coverage of any RSU (e.g., FIG. 2 vehicles 202, 204), or when the RSU is in a passive mode (e.g., configured as a passive monitor and not participating in vehicular communications actively), then V2V certificate distribution may be used.

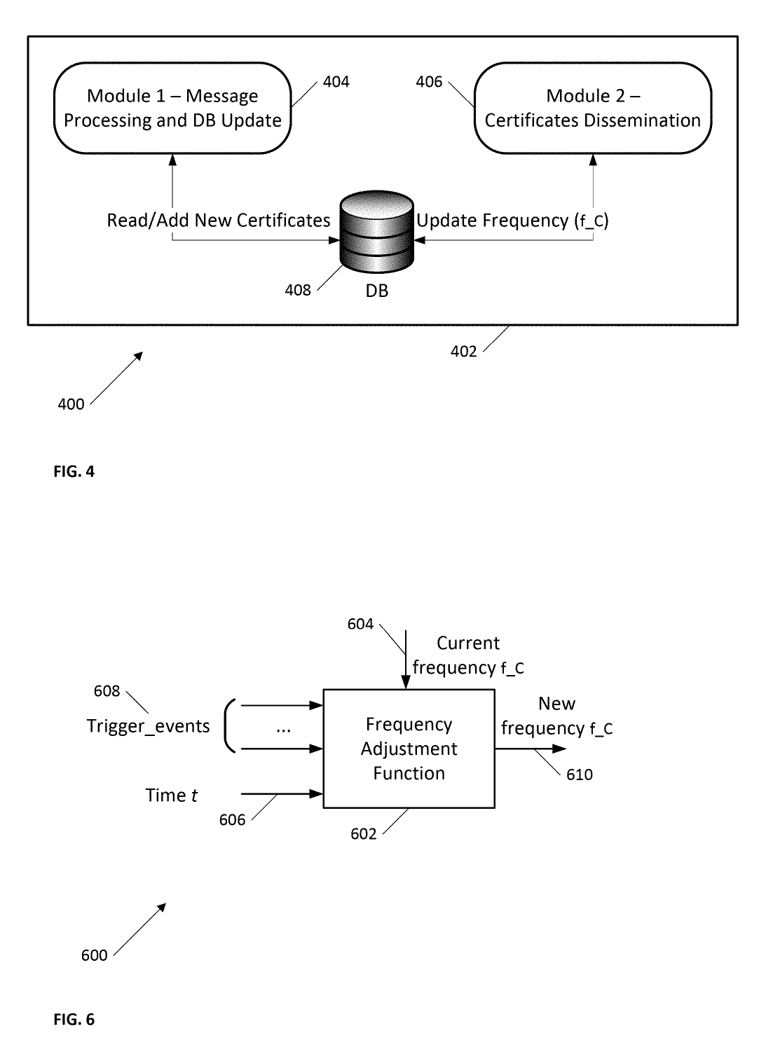

FIG. 4 illustrates an exemplary environment 400 illustrating RSU message monitoring and database update. In the illustrated embodiment, a Road Side Unit (RSU) 402 contains two modules 404, 406. It is assumed the RSU is deployed at some location, e.g., alongside a roadway, at an intersection, in/on/adjacent to a building, in a mobile RSU, co-located with cellular base stations, towers and/or other infrastructure, etc. In WAVE-based vehicular networks, the RSU may be deployed as part of transportation infrastructure. In cellular networks, the RSU may be deployed (co-located or otherwise associated with) cellular infrastructure. The RSU has a known position and is treated as a local certificate management authority. In one embodiment, the RSU may monitor communications between vehicles and/or devices in its neighborhood, broadcast traffic related information and control commands, collect road traffic statistics, perform lawful data and/or communication interception, assist with autonomous driving tasks, etc. In one embodiment, an active RSU (e.g., not passive mode) participates in communications as an active entity, and proactively distributes “necessary” CA certificates and relative certificate chains to vehicles or devices that need or may need them. In one embodiment a distribution list is the list of certificates to be distributed, and the certificates may be distributed in an aggregated fashion. That is, it will be appreciated that the RSU may monitor its environment and determine certificates that vehicles and/or other devices may need to efficiently operate in its neighborhood (e.g., it's coverage area), and rather than piecemeal provide certificates, instead an aggregated package of certificates will be provided to vehicles and/or other devices. It will be appreciated that some recipients of the aggregated certificates may already have the certificate locally and it may ignore duplicates.

In the illustrated embodiment, Module 1 404 monitors and processes incoming messages from vehicles/devices, and adds new certificates (if any) that might be needed for communications among local vehicles/devices into its database (DB) 408 storage. It will be appreciated the DB may be local for speed of accessing data, but it may also be implemented wholly or partially as remote storage accessible over a communication pathway such as the Internet or other network. It will be appreciated policies may be employed to control data retention in local storage and/or data relocation to remote (e.g., cold) storage (not illustrated), or data deletion (e.g., for certificates deemed unnecessary to a particular neighborhood). Module 1 is discussed in more detail below with respect to FIG. 5.

In the illustrated embodiment, Module 2 406 manages the dissemination frequency of certificates, and updates the list of certificates to be disseminated. Module 2 is discussed in more detail below with respect to FIG. 6.

FIG. 5 illustrates an exemplary environment 500 for infrastructured certificate distribution according to one embodiment. In the illustrated embodiment, a new message 502 is received, and a RSU is monitoring communication between vehicles and/or other devices in its neighborhood, and maintains a local database (DB) (e.g., FIG. 4 item 408). The DB may store, among other things, all higher-level certificates (e.g., Certificate Authority (CA) certificates), and corresponding certificate chains that the RSU has received. Metadata associated with the message may be extracted 504. Associated metadata includes, as discussed with respect to FIG. 2, a header, a payload, a signature, and a signing certificate. And as discussed with respect to FIG. 3, each certificate includes its identifier 302 and the issuer's identifier 304. The RSU may query 506 its DB for the certificate associated with the message. In the illustrated embodiment, the query is made with message's certificate id and the certificate issuer's identifier. It will be appreciate in other embodiments other keys/hashes/etc. may be used to track certificates.

If 508 the certificate chain is already inside the DB then the message may be discarded 510. Note that determining if 508 the chain is already known conflates several operations required to make that determination. As discussed above, a certificate chain represents a linked list. By looking at an issuer's identifier for a certificate, and iteratively checking on each issuer, a complete certificate chain can be reconstructed. This may be performed to determine if 508 the chain is already known. In this way, the RSU checks if it has all the certificates on the certificate chain starting with the signing certificate carried in the signed message. If any certificate is not in the RSU's database, the RSU will fetch 512 the rest certificates on the chain (starting from the missing one) from a PKI (e.g., FIG. 2 item 226) and adds them to its local database. As discussed above, in the illustrated embodiment the RSU will proactively provide certificates to vehicles and/or other devices in its neighborhood.

If the fetch 512 of all missing CA certificates fails, e.g., they cannot all be retrieved from a PKI, which may be due to an attempt by a bad actor to interfere with messaging, or if 514 any certificate in the chain cannot be validated (or have been withdrawn or otherwise marked ineligible for use), in one embodiment, the RSU reports 516 problematic certificate(s) to the PKI (or other backend administration entity). However, if all missing certificates could be fetched 512, and if 514 all certificates in the chain are valid, then the RSU adds 518 the newly acquired certificate(s) to its database. In one embodiment, the first time a certificate is added 518 to the DB, the RSU will assign a default frequency f_D for each of them. Distribution and distribution frequency will be discussed further below. It will be appreciated there is no restriction on the types of certificates and/or other data a RSU can retrieve from or send to the PKI or other backend server, remote system, vehicle, other device or even another RSU (one RSU may hand off certificates/other data to another RSU based on predicted movement or metadata or other context associated with a vehicle and/or other device), etc. Therefore, if new types of trust-related credentials or messaging are introduced, such as elector certificates and endorsements such as those proposed in a new version of IEEE 1609.2, the RSU may retrieve and distribute all necessary credentials, e.g., intermediate and root CA certificates, elector certificates and endorsements, as discussed herein.

FIG. 6 illustrates an exemplary environment 600 illustrating adjusting RSU message dissemination frequency. In the illustrated embodiment, an adjustment function 602 takes as input the current broadcast frequency f_C 604, the time t 606, and a set of trigger events 608. The adjustment function outputs a (possibly) new broadcast frequency 610. The “possibly” new refers to the possibility that the adjustment function may keep the frequency the same.

In one embodiment, assume L represents a distribution list, that as discussed above, represents a list of certificates to be periodically broadcasted to vehicles and/or other devices in the RSU neighborhood. L may be distributed periodically at a frequency f=1/T, where T is a system parameter. T determines the periodicity for RSU's certificate distribution and may be adjusted by the RSU based on contextual information, such as the congestion status of the communication channel (i.e., T is set to a large value if the channel is busy). At each scheduled distribution time, L contains only certificates the RSU deems necessary to distribute according to the RSU's observation/predicted distribution needs. In one embodiment L(t) may indicate the list of certificates distributed at distribution time t, where for convenience t is assumed a multiple of T. It will be appreciated L(t) may be different from L(t+T), and if no certificate is necessary at time t, L(t) may be empty and not transmitted. The presence of each certificate (and associated chain) in L(t) depends on a frequency tracked per-certificate, and continuously updated based on RSU observations of neighborhood activity.

In one embodiment f_C may be used to indicate a certificate's distribution frequency where f_C is a fraction off and f is the maximum value for every f_C. In one embodiment, L(t) may be provided through the control channel (CCH), either standalone, or it may be piggybacked into other application/management-specific messages. In another embodiment, to reduce a burden introduced to the CCH, providing L(t) may be treated as a service such that the RSU broadcasts this service with periodic Wave Service Advertisement (WSA) on the CCH. In this embodiment, the RSU distributes L(t) on the target service channel (SCH). Thus, vehicles and/or other devices in the RSU's coverage are notified of the certificate distribution service provided by the RSU, and may switch to the corresponding SCH to fetch the certificates when needed. In one embodiment, vehicles drop a signed message if they are unable to verify it.

In one embodiment, the list L(t) is populated and maintained by updating the per-certificate frequency f_C from a current frequency 604 to the new broadcast frequency 610, and compiling/updating the list L(t) is based on frequencies calculated during the updating. In one embodiment the RSU (or a process within the RSU) monitors its DB. The RSU updates the DB every f_C 604 using the illustrated update function 602. It will be appreciated the per-certificate broadcast frequency f_C for every certificate C varies over time based on RSU's observations of messages and/or other data coming from or associated with vehicles and/or other devices in its neighborhood. Thus, intuitively, when the RSU sees and fetches a new CA certificate while monitoring communications, it should broadcast this certificate (and its associated chain) “more often” as other vehicles and/or other devices in the neighborhood are more likely to need the new CA certificate. If no new CA certificate appears, this implies neighboring vehicles already have all the CA certificates they need for signature verification, and thus, the RSU should broadcast certificates “less frequently”. It will be appreciated trigger events 608 may include a variety of events that impact a broadcast decision. Choice of relevant trigger events may be left to specific application/deployment. In one embodiment, time and accumulation speed of new CA certificates may be triggering events.

To address corner cases, a vehicle may be allowed to send a certificate learning request (with its identity proof, e.g., its long term certificate) directly to a RSU in case it needs to validate a signature immediately, or in case the RSU does not broadcast certificates it needs. Recall the RSU determines what to broadcast based on perceived needs for its neighborhood. If a new vehicle and/or other device enters a RSU's coverage, and certificates on its chain are popular, vehicles and/or other devices in the RSU's neighborhood already know them. According to the tree structure of the public key infrastructure, topmost certificates on certificate chains are “popular” as they are the root CA's certificate or certificates close to the root. As a result, vehicles will likely share the same CAs at the top of their certificate chain and/or know those top/popular certificates. Leveraging this, vehicle may skip sending those popular CA certificates that others already have.

The new vehicle and/or other device does not necessarily know some of the CA certificates that are already known by this neighborhood. As discussed above, the f_C for known certificates is lower and they are broadcast less frequently, if at all. A new vehicle and/or other device may then directly send a certificate learning request to the RSU, asking for certificates it does not have. In one embodiment, the RSU may respond directly to the requestor with the requested information. In another embodiment, the request may be or may additionally be a trigger event 608 for the RSU to increase the current frequency 604 of the certificates in requestor's request.

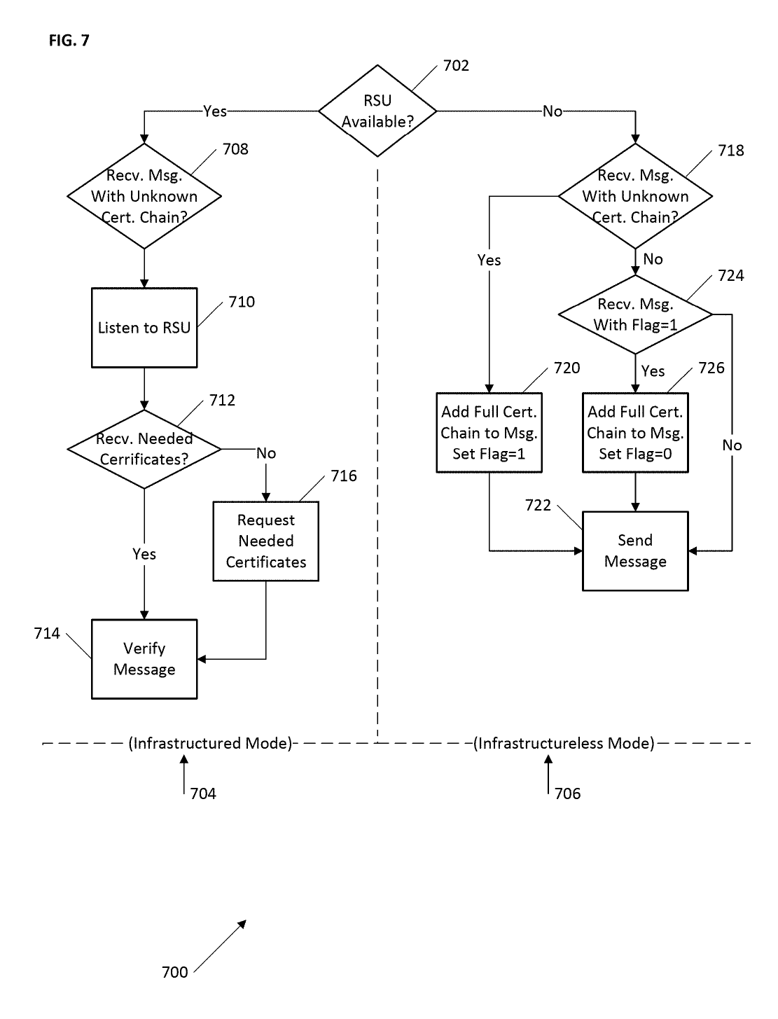

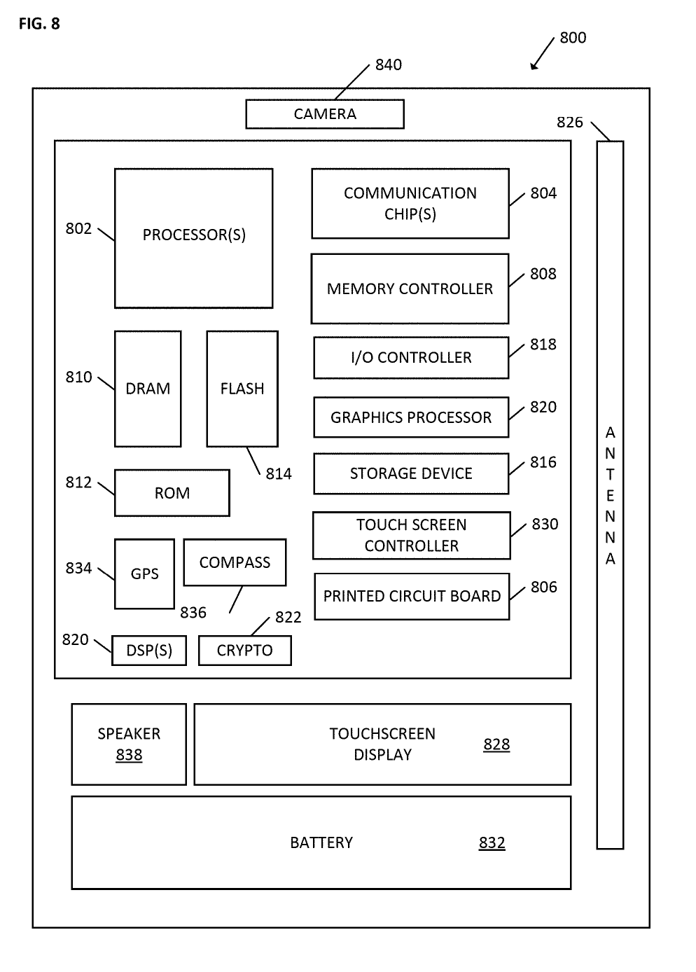

FIG. 7 illustrates an exemplary environment 700 from the perspective of a vehicle or other device operating in infrastructured or infrastructureless mode. For expository convenience, in this illustrated embodiment, let's assume there are three vehicles A, B and C. It will be appreciated however that the term vehicle is for exemplary purposes and that the discussion applies to any device that may operates as discussed with respect to and of FIGS. 1-6. It will be appreciated a device may determine if 702 a RSU is available in a variety of ways, depending on deployment decisions or infrastructure availability. For example, as discussed above with respect to FIG. 6, if a device hears application or management messages such as a certificate list (L) broadcast, Wave Service Advertisements (WSA), or other data periodically broadcast by a RSU, a RSU is known to be available and infrastructured mode 704 should be used. Conversely, if 702 a RSU is not available, then the device knows it should use infrastructureless mode 706.

If 702 a RSU is available, then as discussed above, a vehicle may receive 708, from a new device, a message (e.g., a BSM) with an incomplete certificate chain. See, e.g., FIG. 1 item 106 discussion. The receiving vehicle may listen 710 to the RSU for broadcasts of certificate lists (L) (and/or other data). If 712 the RSU has broadcast the certificates needed to complete the certificate chain, then the vehicle may attempt to verify 714 the message. If 712 the RSU has not broadcast the needed certificates, in the illustrated embodiment, the vehicle may send a request 716 to the RSU for the needed certificates. This is analogous to the FIG. 6 corner case discussed above.

If 702 a RSU is not available, e.g., all vehicles are out of range of a RSU, or all in-range RSUs are in a passive mode, then vehicles may employ a reactive approach to certificate distribution. Without an active/available RSU, if 718 vehicle A receives a message from vehicle B with an unknown valid certificate chain associated with the message, then vehicle A adds 720 its own complete certificate chain, as well as setting a flag=1 in the message, and sends 722 the message. In one embodiment, the message to send may be any scheduled application or management message. In one embodiment, when a vehicle and/or other device enters a new area or comes into contact with new vehicles and/or other devices, the flag set =1 indicates to message receivers that the message was sent by a “newcomer” to a neighborhood/area that is expecting to exchange certificate chains with neighboring vehicles. That is, vehicle A needs to identify the unknown certificate chain. In this example, vehicle A may have recently driven into an area and vehicle B, already present in the area, had sent out a message containing local certificates currently unknown to newcomer vehicle A.

Assuming vehicles B and C are local to the area to which vehicle A has traveled, and vehicles B and C are in range of vehicle A, then they will receive vehicle A's message. As already being local, while what prompted vehicle A to send its message was unknown local certificates, when vehicles B and C test to determine if 718 a message was received with unknown certificates, they will be known. Therefore vehicles B and C (independently and symmetrically) test to see if 724 if the message was received with the flag set=1. If yes, then vehicles B and C know some device, e.g., vehicle A, is in a discovery/certificate learning mode, and therefore vehicles B and C add 726 their full certificate chains to a message and set the flag=0. One exception is that after execution of 724, if the vehicle sees a same complete certificate chain as its own has been sent by another vehicle, it will not execute 726 so as to avoid sending duplicate certificate chains. In one embodiment, vehicles B and C are adding their certificates to their respective next scheduled message to be sent 722. Since vehicles B and C will receive each other's messages, when these messages are receive and tested if 718 any certificates are unknown, they will be known, and when then tested if 724 the flag is set=1, that test will fail and no certificates will be added 726 as discussed above. Vehicle A will also receive the sent 722 messages from vehicles B and C and will store the new certificates, thus adding to its database of certificates in use in the new area.

Thus, in the FIG. 7 embodiment, by using messages with a full certificate chain, and the symmetric approach for both newcomers and more “local” vehicles in a neighborhood, one may quickly exchange and share certificates necessary for further communication. In one embodiment, vehicles discard signed messages if they are unable to verify the signatures. In one embodiment, there may be a threshold for exchanging certificate chains to avoid malicious triggers. For example, a maximum number of messages with complete chain per time period may be predefined. In one embodiment, the IEEE 1609.2 (2016) p2pcdLearningRequest field in the message header may be used as the flag. Further, unlike the IEEE 1609.2 P2PCD protocol, in the illustrated embodiment, a vehicle that starts a certificate chain exchange with its neighbors, needs to add 720 its whole certificate chain, which can be verified by receivers, e.g., vehicles B and C. This may avoid a malicious trigger of the exchange process. In one embodiment, the P2PCD protocol does not have any mechanism to stop triggering the P2PCD process by malicious vehicles. However, in this embodiment, after the predefined maximum number of messages per time period is reached, the messages may be discarded. In another embodiment, as discussed above, the discussion is not limited to exchanging certificates. If, for example, an endorsement P2PCD mechanism is included in the upcoming new version of IEEE 1609.2, the messages from operations 722/724 and operations 726/722 may carry both the full certificate chains as well as the elector information (e.g., elector certificates and endorsement). This allows fast trust credential exchange and reduces the latency of verifying signed messages.

FIG. 8 illustrates an exemplary computer device that may employ the apparatuses and/or methods described herein that may employ apparatuses and/or methods described herein (e.g., for the vehicles and/or other devices of FIGS. 1 and 2, or the FIG. 2 RSU or PKI, etc.), in accordance with various embodiments. As shown, computer device 800 may include a number of components, such as one or more processor(s) 802 (one shown) and at least one communication chip(s) 804. In various embodiments, the one or more processor(s) 802 each may include one or more processor cores. In various embodiments, the at least one communication chip 804 may be physically and electrically coupled to the one or more processor(s) 802. In further implementations, the communication chip(s) 804 may be part of the one or more processor(s) 802. In various embodiments, computer device 800 may include printed circuit board (PCB) 806. For these embodiments, the one or more processor(s) 802 and communication chip(s) 804 may be disposed thereon. In alternate embodiments, the various components may be coupled without the employment of PCB 806.

Depending on its applications, computer device 800 may include other components that may or may not be physically and electrically coupled to the PCB 806. These other components include, but are not limited to, memory controller 808, volatile memory (e.g., dynamic random access memory (DRAM) 810), non-volatile memory such as read only memory (ROM) 812, flash memory 814, storage device 816 (e.g., a hard-disk drive (HDD)), an I/O controller 818, a digital signal processor 820, a crypto processor 822, a graphics processor 824 (e.g., a graphics processing unit (GPU) or other circuitry for performing graphics), one or more antenna 826, a display which may be or work in conjunction with a touch screen display 828, a touch screen controller 830, a battery 832, an audio codec (not shown), a video codec (not shown), a positioning system such as a global positioning system (GPS) device 834 (it will be appreciated other location technology may be used), a compass 836, an accelerometer (not shown), a gyroscope (not shown), a speaker 838, a camera 840, and other mass storage devices (such as hard disk drive, a solid state drive, compact disk (CD), digital versatile disk (DVD)) (not shown), and so forth.

In some embodiments, the one or more processor(s) 802, flash memory 814, and/or storage device 816 may include associated firmware (not shown) storing programming instructions configured to enable computer device 800, in response to execution of the programming instructions by one or more processor(s) 802, to practice all or selected aspects of the methods described herein. In various embodiments, these aspects may additionally or alternatively be implemented using hardware separate from the one or more processor(s) 802, flash memory 814, or storage device 816. In one embodiment, memory, such as flash memory 814 or other memory in the computer device, is or may include a memory device that is a block addressable memory device, such as those based on NAND or NOR technologies. A memory device may also include future generation nonvolatile devices, such as a three dimensional crosspoint memory device, or other byte addressable write-in-place nonvolatile memory devices. In one embodiment, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory. The memory device may refer to the die itself and/or to a packaged memory product.

In various embodiments, one or more components of the computer device 800 may implement an embodiment of the FIG. 2 RSU 220, portions of the vehicles 202-208, or the like. It will be appreciated the vehicles and/or other devices, RSUs, PKIs, and other backend devices may incorporate or be incorporated into the computer device. Thus for example processor 802 could be part of a RSU communicating with memory 810 though memory controller 808 to, for example, manage updating certificate distribution as discussed with respect to FIG. 3. In some embodiments, I/O controller 818 may interface with one or more external devices to receive a data. Additionally, or alternatively, the external devices may be used to receive a data signal transmitted between components of the computer device 800.

The communication chip(s) 804 may enable wired and/or wireless communications for the transfer of data to and from the computer device 800. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. The communication chip(s) may implement any of a number of wireless standards or protocols, including but not limited to IEEE 802.20, Long Term Evolution (LTE), LTE Advanced (LTE-A), General Packet Radio Service (GPRS), Evolution Data Optimized (Ev-DO), Evolved High Speed Packet Access (HSPA+), Evolved High Speed Downlink Packet Access (HSDPA+), Evolved High Speed Uplink Packet Access (HSUPA+), Global System for Mobile Communications (GSM), Enhanced Data rates for GSM Evolution (EDGE), Code Division Multiple Access (CDMA), Time Division Multiple Access (TDMA), Digital Enhanced Cordless Telecommunications (DECT), Worldwide Interoperability for Microwave Access (WiMAX), Bluetooth, derivatives thereof, as well as any other wireless protocols that are designated as 3G, 4G, 5G, and beyond. The computer device may include a plurality of communication chips 804. For instance, a first communication chip(s) may be dedicated to shorter range wireless communications such as Wi-Fi and Bluetooth, and a second communication chip 804 may be dedicated to longer range wireless communications such as GPS, EDGE, GPRS, CDMA, WiMAX, LTE, Ev-DO, and others.

The communication chip(s) may implement any number of standards, protocols, and/or technologies datacenters typically use, such as networking technology providing high-speed low latency communication. For example the communication chip(s) may support RoCE (Remote Direct Memory Access (RDMA) over Converged Ethernet), e.g., version 1 or 2, which is a routable protocol having efficient data transfers across a network, and is discussed for example at Internet URL RDMAconsortium.com. The chip(s) may support Fibre Channel over Ethernet (FCoE), iWARP, or other high-speed communication technology, see for example the OpenFabrics Enterprise Distribution (OFED™) documentation available at Internet URL OpenFabrics.org. It will be appreciated datacenter environments benefit from highly efficient networks, storage connectivity and scalability, e.g., Storage Area Networks (SANS), parallel computing using RDMA, Internet Wide Area Remote Protocol (iWARP), InfiniBand Architecture (IBA), and other such technology. Computer device 800 may support any of the infrastructures, protocols and technology identified here, and since new high-speed technology is always being implemented, it will be appreciated by one skilled in the art that the computer device is expected to support equivalents currently known or technology implemented in future.

In various implementations, the computer device 800 may be a laptop, a netbook, a notebook, an ultrabook, a smartphone, a computer tablet, a personal digital assistant (PDA), an ultra-mobile PC, a mobile phone, a desktop computer, a server, a printer, a scanner, a monitor, a set-top box, an entertainment control unit (e.g., a gaming console or automotive entertainment unit), a digital camera, an appliance, a portable music player, or a digital video recorder, or a transportation device (e.g., any motorized or manual device such as a bicycle, motorcycle, automobile, taxi, train, plane, etc.). In further implementations, the computer device 800 may be any other electronic device that processes data.

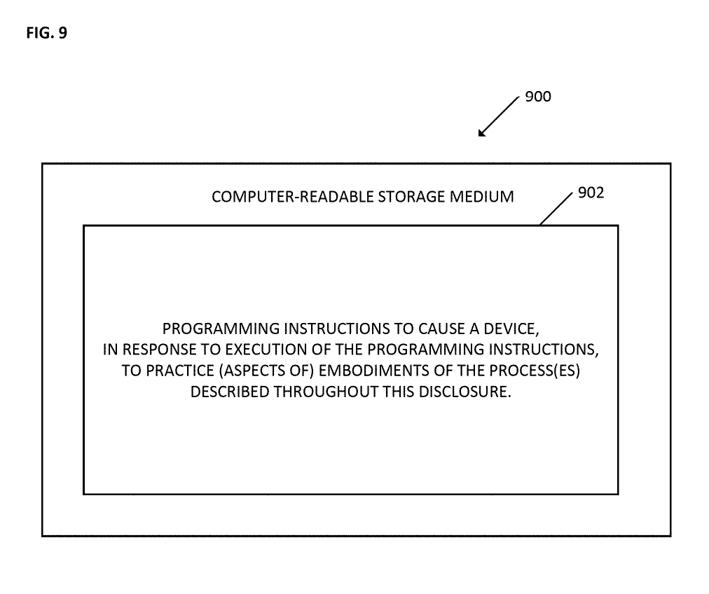

FIG. 9 illustrates an exemplary computer-accessible storage medium. The phrase “storage medium” is used herein to generally refer to any type of computer-accessible, computer-usable or computer-readable storage medium or combination of media. It will be appreciated a storage medium may be transitory, non-transitory or some combination of transitory and non-transitory media, and the storage medium may be suitable for use to store instructions that cause an apparatus, machine or other device, in response to execution of the instructions by the apparatus, to practice selected aspects of the present disclosure. As will be appreciated by one skilled in the art, the present disclosure may be embodied as methods or computer program products. Accordingly, the present disclosure, in addition to being embodied in hardware as earlier described, may take the form of an entirely software embodiment (including firmware, resident software, micro-code, etc.) or an embodiment combining software and hardware aspects that may all generally be referred to as a “circuit,” “module” or “system.” Furthermore, the present disclosure may take the form of a computer program product embodied in any tangible or non-transitory medium of expression having computer-usable program code embodied in the medium. As shown, computer-accessible storage medium 900 may include a number of programming instructions 902. Programming instructions may be configured to enable a device, e.g., FIG. 8 computer device 800, in response to execution of the programming instructions, to implement (aspects of) a node executing internal software to manage monitoring sensors, recording events and if needed, updating an output such as a display to alter an initial plan for the node. The programming instructions may be used to operate other devices disclosed herein such as with respect to the disclosed embodiments for FIGS. 1-7. In alternate embodiments, programming instructions may be disposed on multiple computer-readable transitory and/or non-transitory storage media. In other embodiments, programming instructions may be disposed on computer-readable storage media and/or computer-accessible media, such as, signals.

Any combination of one or more storage medium may be utilized. The storage medium may be, for example but not limited to, an electronic, magnetic, optical, electromagnetic, infrared, or semiconductor system, apparatus, device, or propagation medium. More specific examples (a non-exhaustive list) of the storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the storage medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a storage medium may be any medium that can contain, store, communicate, propagate, or transport the program for use by or in connection with the instruction execution system, apparatus, or device. The computer-accessible storage medium may include a propagated data signal with the computer-usable program code embodied therewith, either in baseband or as part of a carrier wave. The program code may be transmitted using any appropriate medium, including but not limited to wireless, wireline, optical fiber cable, RF, etc.

Computer-usable program code for carrying out operations of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. It will be appreciated program code may operate as a distributed task operating on multiple machines cooperatively working to perform program code. In various embodiments, a remote computer may be connected to the user's computer through any type of network, including a local area network (LAN) or a wide area network (WAN), or the connection may be made to an external computer (for example, through the Internet using an Internet Service Provider). Cooperative program execution may be for a fee based on a commercial transaction, such as a negotiated rate (offer/accept) arrangement, established and/or customary rates, and may include micropayments between device(s) cooperatively executing the program or storing and/or managing associated data.

These computer program instructions may be stored in a storage medium that can direct a computer or other programmable data processing apparatus to function in a particular manner, such that the instructions stored in the storage medium produce an article of manufacture including instruction means which implement the function/act specified in the flowchart and/or block diagram block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

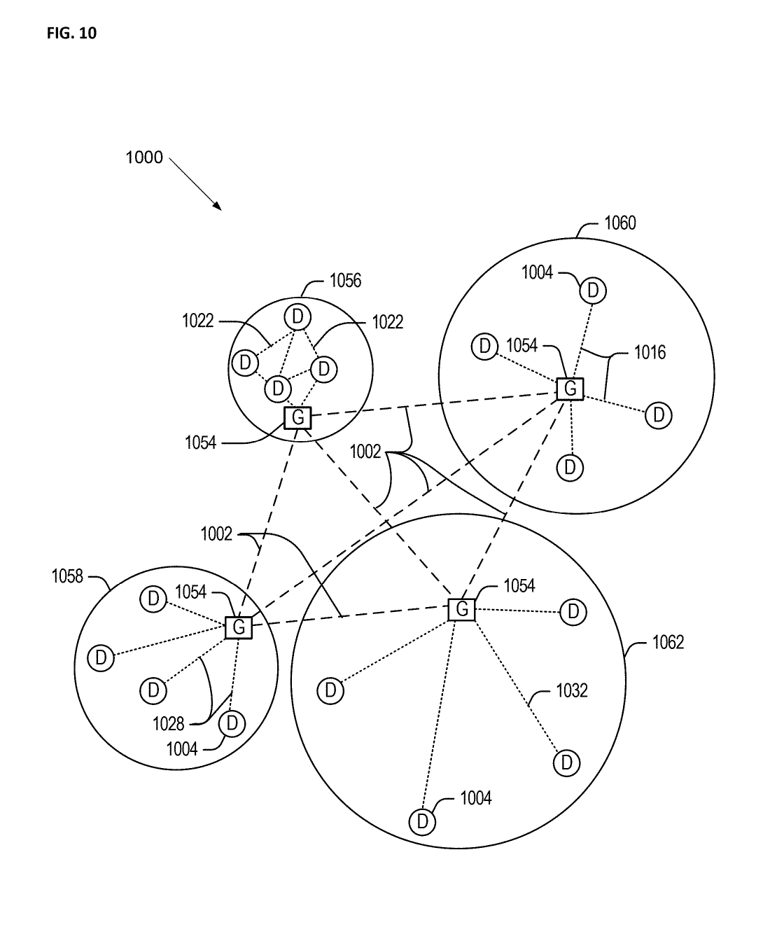

FIG. 10 illustrates an example domain topology 1000 for respective internet-of-things (IoT) networks coupled through links to respective gateways.

Often, IoT devices are limited in memory, size, or functionality, allowing larger numbers to be deployed for a similar cost to smaller numbers of larger devices. However, an IoT device may be a smart phone, laptop, tablet, or PC, or other larger device. Further, an IoT device may be a virtual device, such as an application on a smart phone or other computing device. IoT devices may include IoT gateways, used to couple IoT devices to other IoT devices and to cloud applications, for data storage, process control, and the like.

Networks of IoT devices may include commercial and home automation devices, such as water distribution systems, electric power distribution systems, pipeline control systems, plant control systems, light switches, thermostats, locks, cameras, alarms, motion sensors, and the like. The IoT devices may be accessible through remote computers, servers, and other systems, for example, to control systems or access data.

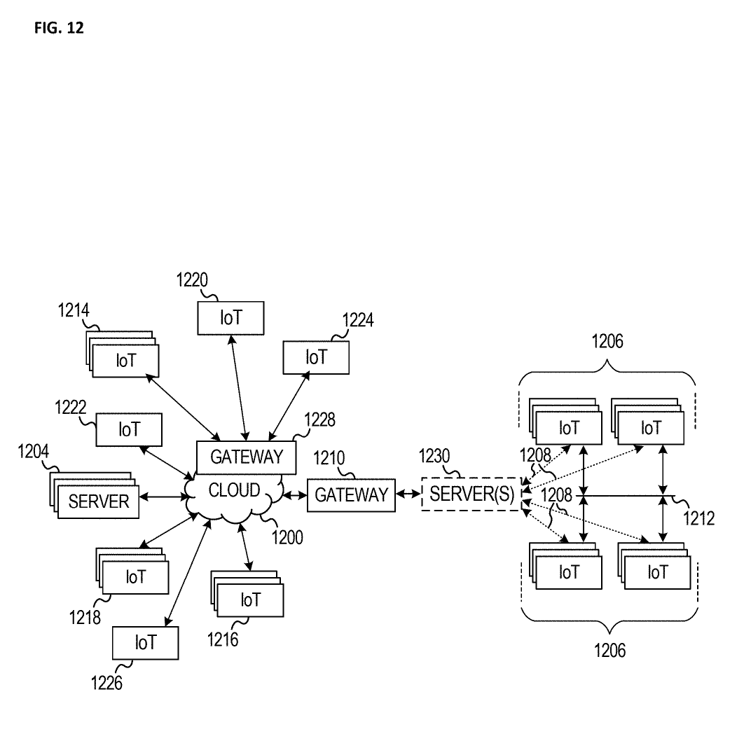

The future growth of the Internet and like networks may involve very large numbers of IoT devices. Accordingly, in the context of the techniques discussed herein, a number of innovations for such future networking will address the need for all these layers to grow unhindered, to discover and make accessible connected resources, and to support the ability to hide and compartmentalize connected resources. Any number of network protocols and communications standards may be used, wherein each protocol and standard is designed to address specific objectives. Further, the protocols are part of the fabric supporting human accessible services that operate regardless of location, time or space. The innovations include service delivery and associated infrastructure, such as hardware and software; security enhancements; and the provision of services based on Quality of Service (QoS) terms specified in service level and service delivery agreements. As will be understood, the use of IoT devices and networks, such as those introduced in FIGS. 10 and 12, present a number of new challenges in a heterogeneous network of connectivity comprising a combination of wired and wireless technologies.

FIG. 10 specifically provides a simplified drawing of a domain topology that may be used for a number of internet-of-things (IoT) networks comprising IoT devices 1004, with the IoT networks 1056, 1058, 1060, 1062, coupled through backbone links 1002 to respective gateways 1054. For example, a number of IoT devices 1004 may communicate with a gateway 1054, and with each other through the gateway 1054. To simplify the drawing, not every IoT device 1004, or communications link (e.g., link 1016, 1022, 1028, or 1032) is labeled. The backbone links 1002 may include any number of wired or wireless technologies, including optical networks, and may be part of a local area network (LAN), a wide area network (WAN), or the Internet. Additionally, such communication links facilitate optical signal paths among both IoT devices 1004 and gateways 1054, including the use of MUXing/deMUXing components that facilitate interconnection of the various devices.

The network topology may include any number of types of IoT networks, such as a mesh network provided with the network 1056 using Bluetooth low energy (BLE) links 1022. Other types of IoT networks that may be present include a wireless local area network (WLAN) network 1058 used to communicate with IoT devices 1004 through IEEE 802.8 (Wi-Fi®) links 1028, a cellular network 1060 used to communicate with IoT devices 1004 through an LTE/LTE-A 4G) or 5G cellular network, and a low-power wide area (LPWA) network 1062, for example, a LPWA network compatible with the LoRaWan specification promulgated by the LoRa alliance, or a IPv6 over Low Power Wide-Area Networks (LPWAN) network compatible with a specification promulgated by the Internet Engineering Task Force (IETF). Further, the respective IoT networks may communicate with an outside network provider (e.g., a tier 2 or tier 3 provider) using any number of communications links, such as an LTE cellular link, an LPWA link, or a link based on the IEEE 802.15.4 standard, such as Zigbee®. The respective IoT networks may also operate with use of a variety of network and internet application protocols such as Constrained Application Protocol (CoAP). The respective IoT networks may also be integrated with coordinator devices that provide a chain of links that forms cluster tree of linked devices and networks.

Each of these IoT networks may provide opportunities for new technical features, such as those as described herein. The improved technologies and networks may enable the exponential growth of devices and networks, including the use of IoT networks into as fog devices or systems. As the use of such improved technologies grows, the IoT networks may be developed for self-management, functional evolution, and collaboration, without needing direct human intervention. The improved technologies may even enable IoT networks to function without centralized controlled systems. Accordingly, the improved technologies described herein may be used to automate and enhance network management and operation functions far beyond current implementations.

In an example, communications between IoT devices 1004, such as over the backbone links 1002, may be protected by a decentralized system for authentication, authorization, and accounting (AAA). In a decentralized AAA system, distributed payment, credit, audit, authorization, and authentication systems may be implemented across interconnected heterogeneous network infrastructure. This allows systems and networks to move towards autonomous operations. In these types of autonomous operations, machines may even contract for human resources and negotiate partnerships with other machine networks. This may allow the achievement of mutual objectives and balanced service delivery against outlined, planned service level agreements as well as achieve solutions that provide metering, measurements, traceability and trackability. The creation of new supply chain structures and methods may enable a multitude of services to be created, mined for value, and collapsed without any human involvement.

Such IoT networks may be further enhanced by the integration of sensing technologies, such as sound, light, electronic traffic, facial and pattern recognition, smell, vibration, into the autonomous organizations among the IoT devices. The integration of sensory systems may allow systematic and autonomous communication and coordination of service delivery against contractual service objectives, orchestration and quality of service (QoS) based swarming and fusion of resources. Some of the individual examples of network-based resource processing include the following.

The mesh network 1056, for instance, may be enhanced by systems that perform inline data-to-information transforms. For example, self-forming chains of processing resources comprising a multi-link network may distribute the transformation of raw data to information in an efficient manner, and the ability to differentiate between assets and resources and the associated management of each. Furthermore, the proper components of infrastructure and resource based trust and service indices may be inserted to improve the data integrity, quality, assurance and deliver a metric of data confidence.

The WLAN network 1058, for instance, may use systems that perform standards conversion to provide multi-standard connectivity, enabling IoT devices 1004 using different protocols to communicate. Further systems may provide seamless interconnectivity across a multi-standard infrastructure comprising visible Internet resources and hidden Internet resources.

Communications in the cellular network 1060, for instance, may be enhanced by systems that offload data, extend communications to more remote devices, or both. The LPWA network 1062 may include systems that perform non-Internet protocol (IP) to IP interconnections, addressing, and routing. Further, each of the IoT devices 1004 may include the appropriate transceiver for wide area communications with that device. Further, each IoT device 1004 may include other transceivers for communications using additional protocols and frequencies. This is discussed further with respect to the communication environment and hardware of an IoT processing device depicted in other illustrated embodiments.

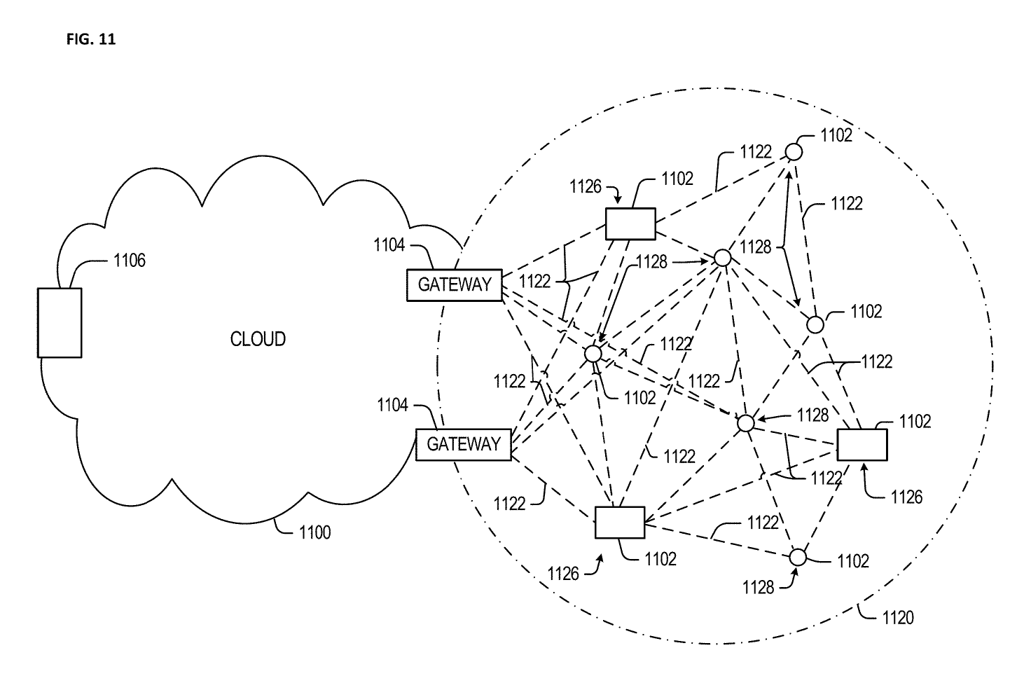

Finally, clusters of IoT devices may be equipped to communicate with other IoT devices as well as with a cloud network. This may allow the IoT devices to form an ad-hoc network between the devices, allowing them to function as a single device, which may be termed a fog device. This configuration is discussed further with respect to FIG. 11 below.

FIG. 11 illustrates a cloud computing network in communication with a mesh network of IoT devices (devices 1102) operating as a fog device at the edge of the cloud computing network. The mesh network of IoT devices may be termed a fog 1120, operating at the edge of the cloud 1100. To simplify the diagram, not every IoT device 1102 is labeled.

The fog 1120 may be considered to be a massively interconnected network wherein a number of IoT devices 1102 are in communications with each other, for example, by radio links 1122. As an example, this interconnected network may be facilitated using an interconnect specification released by the Open Connectivity Foundation™ (OCF). This standard allows devices to discover each other and establish communications for interconnects. Other interconnection protocols may also be used, including, for example, the optimized link state routing (OLSR) Protocol, the better approach to mobile ad-hoc networking (B.A.T.M.A.N.) routing protocol, or the OMA Lightweight M2M (LWM2M) protocol, among others.

Three types of IoT devices 1102 are shown in this example, gateways 1104, data aggregators 1126, and sensors 1128, although any combinations of IoT devices 1102 and functionality may be used. The gateways 1104 may be edge devices that provide communications between the cloud 1100 and the fog 1120, and may also provide the backend process function for data obtained from sensors 1128, such as motion data, flow data, temperature data, and the like. The data aggregators 1126 may collect data from any number of the sensors 1128, and perform the back end processing function for the analysis. The results, raw data, or both may be passed along to the cloud 1100 through the gateways 1104. The sensors 1128 may be full IoT devices 1102, for example, capable of both collecting data and processing the data. In some cases, the sensors 1128 may be more limited in functionality, for example, collecting the data and allowing the data aggregators 1126 or gateways 1104 to process the data.

Communications from any IoT device 1102 may be passed along a convenient path (e.g., a most convenient path) between any of the IoT devices 1102 to reach the gateways 1104. In these networks, the number of interconnections provide substantial redundancy, allowing communications to be maintained, even with the loss of a number of IoT devices 1102. Further, the use of a mesh network may allow IoT devices 1102 that are very low power or located at a distance from infrastructure to be used, as the range to connect to another IoT device 1102 may be much less than the range to connect to the gateways 1104.

The fog 1120 provided from these IoT devices 1102 may be presented to devices in the cloud 1100, such as a server 1106, as a single device located at the edge of the cloud 1100, e.g., a fog device. In this example, the alerts coming from the fog device may be sent without being identified as coming from a specific IoT device 1102 within the fog 1120. In this fashion, the fog 1120 may be considered a distributed platform that provides computing and storage resources to perform processing or data-intensive tasks such as data analytics, data aggregation, and machine-learning, among others.

In some examples, the IoT devices 1102 may be configured using an imperative programming style, e.g., with each IoT device 1102 having a specific function and communication partners. However, the IoT devices 1102 forming the fog device may be configured in a declarative programming style, allowing the IoT devices 1102 to reconfigure their operations and communications, such as to determine needed resources in response to conditions, queries, and device failures. As an example, a query from a user located at a server 1106 about the operations of a subset of equipment monitored by the IoT devices 1102 may result in the fog 1120 device selecting the IoT devices 1102, such as particular sensors 1128, needed to answer the query. The data from these sensors 1128 may then be aggregated and analyzed by any combination of the sensors 1128, data aggregators 1126, or gateways 1104, before being sent on by the fog 1120 device to the server 1106 to answer the query. In this example, IoT devices 1102 in the fog 1120 may select the sensors 1128 used based on the query, such as adding data from flow sensors or temperature sensors. Further, if some of the IoT devices 1102 are not operational, other IoT devices 1102 in the fog 1120 device may provide analogous data, if available.

In other examples, the operations and functionality described above may be embodied by a IoT device machine in the example form of an electronic processing system, within which a set or sequence of instructions may be executed to cause the electronic processing system to perform any one of the methodologies discussed herein, according to an example embodiment. The machine may be an IoT device or an IoT gateway, including a machine embodied by aspects of a personal computer (PC), a tablet PC, a personal digital assistant (PDA), a mobile telephone or smartphone, or any machine capable of executing instructions (sequential or otherwise) that specify actions to be taken by that machine. Further, while only a single machine may be depicted and referenced in the example above, such machine shall also be taken to include any collection of machines that individually or jointly execute a set (or multiple sets) of instructions to perform any one or more of the methodologies discussed herein. Further, these and like examples to a processor-based system shall be taken to include any set of one or more machines that are controlled by or operated by a processor (e.g., a computer) to individually or jointly execute instructions to perform any one or more of the methodologies discussed herein.

FIG. 12 illustrates a drawing of a cloud computing network, or cloud 1200, in communication with a number of Internet of Things (IoT) devices. The cloud 1200 may represent the Internet, or may be a local area network (LAN), or a wide area network (WAN), such as a proprietary network for a company. The IoT devices may include any number of different types of devices, grouped in various combinations. For example, a traffic control group 1206 may include IoT devices along streets in a city. These IoT devices may include stoplights, traffic flow monitors, cameras, weather sensors, RSUs, and the like. The traffic control group 1206, or other subgroups, may be in communication with the cloud 1200 through wired or wireless links 1208, such as LPWA links, optical links, and the like. Further, a wired or wireless sub-network 1212 may allow the IoT devices to communicate with each other, such as through a local area network, a wireless local area network, and the like. The IoT devices may use another device, such as a gateway 1210 or 1228 to communicate with remote locations such as the cloud 1200; the IoT devices may also use one or more servers 1230 to facilitate communication with the cloud 1200 or with the gateway 1210. For example, the one or more servers 1230 may operate as an intermediate network node to support a local edge cloud or fog implementation among a local area network. Further, the gateway 1228 that is depicted may operate in a cloud-to-gateway-to-many edge devices configuration, such as with the various IoT devices 1214, 1220, 1224 being constrained or dynamic to an assignment and use of resources in the cloud 1200.

Other example groups of IoT devices may include remote weather stations 1214, local information terminals 1216, alarm systems 1218, automated teller machines 1220, alarm panels 1222, or moving vehicles, such as emergency vehicles 1224 or other vehicles 1226, among many others. Each of these IoT devices may be in communication with other IoT devices, with servers 1204, with another IoT fog device or system (not shown, but depicted in FIG. 11), or a combination therein. The groups of IoT devices may be deployed in various residential, commercial, and industrial settings (including in both private or public environments).

As can be seen from FIG. 12, a large number of IoT devices may be communicating through the cloud 1200. This may allow different IoT devices to request or provide information to other devices autonomously. For example, a group of IoT devices (e.g., the traffic control group 1206) may request a current weather forecast from a group of remote weather stations 1214, which may provide the forecast without human intervention. Further, an emergency vehicle 1224 may be alerted by an automated teller machine 1220 that a burglary is in progress. As the emergency vehicle 1224 proceeds towards the automated teller machine 1220, it may access the traffic control group 1206 to request clearance to the location, for example, by lights turning red to block cross traffic at an intersection in sufficient time for the emergency vehicle 1224 to have unimpeded access to the intersection.

Clusters of IoT devices, such as the remote weather stations 1214 or the traffic control group 1206, may be equipped to communicate with other IoT devices as well as with the cloud 1200. This may allow the IoT devices to form an ad-hoc network between the devices, allowing them to function as a single device, which may be termed a fog device or system (e.g., as described above with reference to FIG. 11).

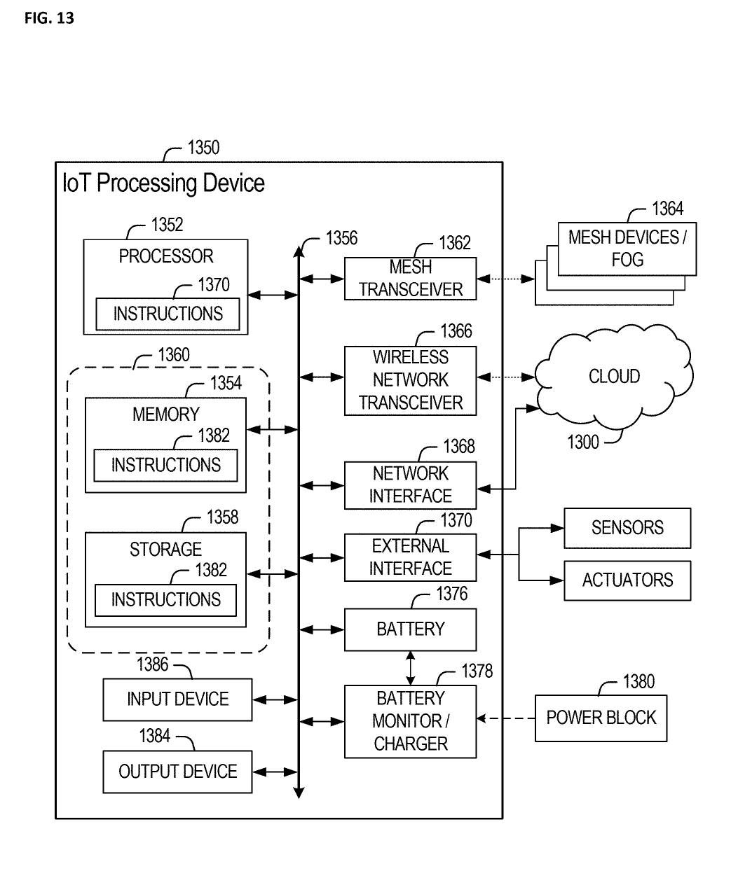

FIG. 13 is a block diagram of an example of components that may be present in an IoT device 1350 for implementing the techniques described herein. The IoT device 1350 may include any combinations of the components shown in the example or referenced in the disclosure above. The components may be implemented as ICs, portions thereof, discrete electronic devices, or other modules, logic, hardware, software, firmware, or a combination thereof adapted in the IoT device 1350, or as components otherwise incorporated within a chassis of a larger system. Additionally, the block diagram of FIG. 13 is intended to depict a high-level view of components of the IoT device 1350. However, some of the components shown may be omitted, additional components may be present, and different arrangement of the components shown may occur in other implementations.

The IoT device 1350 may include a processor 1352, which may be a microprocessor, a multi-core processor, a multithreaded processor, an ultra-low voltage processor, an embedded processor, or other known processing element. The processor 1352 may be a part of a system on a chip (SoC) in which the processor 1352 and other components are formed into a single integrated circuit, or a single package, such as the Edison™ or Galileo™ SoC boards from Intel. As an example, the processor 1352 may include an Intel® Architecture Core™ based processor, such as a Quark™, an Atom™, an i3, an i5, an i7, or an MCU-class processor, or another such processor available from Intel® Corporation, Santa Clara, Calif. However, any number other processors may be used, such as available from Advanced Micro Devices, Inc. (AMD) of Sunnyvale, Calif., a MIPS-based design from MIPS Technologies, Inc. of Sunnyvale, Calif., an ARM-based design licensed from ARM Holdings, Ltd. or customer thereof, or their licensees or adopters. The processors may include units such as an A5-A10 processor from Apple® Inc., a Snapdragon™ processor from Qualcomm® Technologies, Inc., or an OMAP™ processor from Texas Instruments, Inc.

The processor 1352 may communicate with a system memory 1354 over an interconnect 1356 (e.g., a bus). Any number of memory devices may be used to provide for a given amount of system memory. As examples, the memory may be random access memory (RAM) in accordance with a Joint Electron Devices Engineering Council (JEDEC) design such as the DDR or mobile DDR standards (e.g., LPDDR, LPDDR2, LPDDR3, or LPDDR4). In various implementations the individual memory devices may be of any number of different package types such as single die package (SDP), dual die package (DDP) or quad die package (Q17P). These devices, in some examples, may be directly soldered onto a motherboard to provide a lower profile solution, while in other examples the devices are configured as one or more memory modules that in turn couple to the motherboard by a given connector. Any number of other memory implementations may be used, such as other types of memory modules, e.g., dual inline memory modules (DIMMs) of different varieties including but not limited to microDIMMs or MiniDIMMs.

To provide for persistent storage of information such as data, applications, operating systems and so forth, a storage 1358 may also couple to the processor 1352 via the interconnect 1356. In an example the storage 1358 may be implemented via a solid state disk drive (SSDD). Other devices that may be used for the storage 1358 include flash memory cards, such as SD cards, microSD cards, xD picture cards, and the like, and USB flash drives. In low power implementations, the storage 1358 may be on-die memory or registers associated with the processor 1352. However, in some examples, the storage 1358 may be implemented using a micro hard disk drive (HDD). Further, any number of new technologies may be used for the storage 1358 in addition to, or instead of, the technologies described, such resistance change memories, phase change memories, holographic memories, or chemical memories, among others.

The components may communicate over the interconnect 1356. The interconnect 1356 may include any number of technologies, including industry standard architecture (ISA), extended ISA (EISA), peripheral component interconnect (PCI), peripheral component interconnect extended (PCIx), PCI express (PCIe), or any number of other technologies. The interconnect 1356 may be a proprietary bus, for example, used in a SoC based system. Other bus systems may be included, such as an I2C interface, an SPI interface, point to point interfaces, and a power bus, among others.

The interconnect 1356 may couple the processor 1352 to a mesh transceiver 1362, for communications with other mesh devices 1364. The mesh transceiver 1362 may use any number of frequencies and protocols, such as 2.4 Gigahertz (GHz) transmissions under the IEEE 802.15.4 standard, using the Bluetooth° low energy (BLE) standard, as defined by the Bluetooth® Special Interest Group, or the ZigBee® standard, among others. Any number of radios, configured for a particular wireless communication protocol, may be used for the connections to the mesh devices 1364. For example, a WLAN unit may be used to implement Wi-FiTM communications in accordance with the Institute of Electrical and Electronics Engineers (IEEE) 802.11 standard. In addition, wireless wide area communications, e.g., according to a cellular or other wireless wide area protocol, may occur via a WWAN unit.

The mesh transceiver 1362 may communicate using multiple standards or radios for communications at different range. For example, the IoT device 1350 may communicate with close devices, e.g., within about 10 meters, using a local transceiver based on BLE, or another low power radio, to save power. More distant mesh devices 1364, e.g., within about 50 meters, may be reached over ZigBee or other intermediate power radios. Both communications techniques may take place over a single radio at different power levels, or may take place over separate transceivers, for example, a local transceiver using BLE and a separate mesh transceiver using ZigBee.

A wireless network transceiver 1366 may be included to communicate with devices or services in the cloud 1300 via local or wide area network protocols. The wireless network transceiver 1366 may be a LPWA transceiver that follows the IEEE 802.15.4, or IEEE 802.15.4g standards, among others. The IoT device 1350 may communicate over a wide area using LoRaWAN™ (Long Range Wide Area Network) developed by Semtech and the LoRa Alliance. The techniques described herein are not limited to these technologies, but may be used with any number of other cloud transceivers that implement long range, low bandwidth communications, such as Sigfox, and other technologies. Further, other communications techniques, such as time-slotted channel hopping, described in the IEEE 802.15.4e specification may be used.

Any number of other radio communications and protocols may be used in addition to the systems mentioned for the mesh transceiver 1362 and wireless network transceiver 1366, as described herein. For example, the radio transceivers 1362 and 1366 may include an LTE or other cellular transceiver that uses spread spectrum (SPA/SAS) communications for implementing high speed communications. Further, any number of other protocols may be used, such as Wi-Fi® networks for medium speed communications and provision of network communications.

The radio transceivers 1362 and 1366 may include radios that are compatible with any number of 3GPP (Third Generation Partnership Project) specifications, notably Long Term Evolution (LTE), Long Term Evolution-Advanced (LTE-A), and Long Term Evolution-Advanced Pro (LTE-A Pro). It can be noted that radios compatible with any number of other fixed, mobile, or satellite communication technologies and standards may be selected. These may include, for example, any Cellular Wide Area radio communication technology, which may include e.g. a 5th Generation (5G) communication systems, a Global System for Mobile Communications (GSM) radio communication technology, a General Packet Radio Service (GPRS) radio communication technology, or an Enhanced Data Rates for GSM Evolution (EDGE) radio communication technology, a UMTS (Universal Mobile Telecommunications System) communication technology, In addition to the standards listed above, any number of satellite uplink technologies may be used for the wireless network transceiver 1366, including, for example, radios compliant with standards issued by the ITU (International Telecommunication Union), or the ETSI (European Telecommunications Standards Institute), among others. The examples provided herein are thus understood as being applicable to various other communication technologies, both existing and not yet formulated.

A network interface controller (NIC) 1368 may be included to provide a wired communication to the cloud 1300 or to other devices, such as the mesh devices 1364. The wired communication may provide an Ethernet connection, or may be based on other types of networks, such as Controller Area Network (CAN), Local Interconnect Network (LIN), DeviceNet, ControlNet, Data Highway+, PROFIBUS, or PROFINET, among many others. An additional NIC 1368 may be included to allow connect to a second network, for example, a NIC 1368 providing communications to the cloud over Ethernet, and a second NIC 1368 providing communications to other devices over another type of network.

The interconnect 1356 may couple the processor 1352 to an external interface 1370 that is used to connect external devices or subsystems. The external devices may include sensors 1372, such as accelerometers, level sensors, flow sensors, optical light sensors, camera sensors, temperature sensors, a global positioning system (GPS) sensors, pressure sensors, barometric pressure sensors, and the like. The external interface 1370 further may be used to connect the IoT device 1350 to actuators 1374, such as power switches, valve actuators, an audible sound generator, a visual warning device, and the like.

In some optional examples, various input/output (I/O) devices may be present within, or connected to, the IoT device 1350. For example, a display or other output device 1384 may be included to show information, such as sensor readings or actuator position. An input device 1386, such as a touch screen or keypad may be included to accept input. An output device 1384 may include any number of forms of audio or visual display, including simple visual outputs such as binary status indicators (e.g., LEDs) and multi-character visual outputs, or more complex outputs such as display screens (e.g., LCD screens), with the output of characters, graphics, multimedia objects, and the like being generated or produced from the operation of the IoT device 1350.

A battery 1376 may power the IoT device 1350, although in examples in which the IoT device 1350 is mounted in a fixed location, it may have a power supply coupled to an electrical grid. The battery 1376 may be a lithium ion battery, or a metal-air battery, such as a zinc-air battery, an aluminum-air battery, a lithium-air battery, and the like.

A battery monitor/charger 1378 may be included in the IoT device 1350 to track the state of charge (SoCh) of the battery 1376. The battery monitor/charger 1378 may be used to monitor other parameters of the battery 1376 to provide failure predictions, such as the state of health (SoH) and the state of function (SoF) of the battery 1376. The battery monitor/charger 1378 may include a battery monitoring integrated circuit, such as an LTC4020 or an LTC2990 from Linear Technologies, an ADT7488A from ON Semiconductor of Phoenix Arizona, or an IC from the UCD90xxx family from Texas Instruments of Dallas, Tex. The battery monitor/charger 1378 may communicate the information on the battery 1376 to the processor 1352 over the interconnect 1356. The battery monitor/charger 1378 may also include an analog-to-digital (ADC) convertor that allows the processor 1352 to monitor directly the voltage of the battery 1376 or the current flow from the battery 1376. The battery parameters may be used to determine actions that the IoT device 1350 may perform, such as transmission frequency, mesh network operation, sensing frequency, and the like.

A power block 1380, or other power supply coupled to a grid, may be coupled with the battery monitor/charger 1378 to charge the battery 1376. In some examples, the power block 1380 may be replaced with a wireless power receiver to obtain the power wirelessly, for example, through a loop antenna in the IoT device 1350. A wireless battery charging circuit, such as an LTC4020 chip from Linear Technologies of Milpitas, Calif., among others, may be included in the battery monitor/charger 1378. The specific charging circuits chosen depend on the size of the battery 1376, and thus, the current required. The charging may be performed using the Airfuel standard promulgated by the Airfuel Alliance, the Qi wireless charging standard promulgated by the Wireless Power Consortium, or the Rezence charging standard, promulgated by the Alliance for Wireless Power, among others.

The storage 1358 may include instructions 1382 in the form of software, firmware, or hardware commands to implement the techniques described herein. Although such instructions 1382 are shown as code blocks included in the memory 1354 and the storage 1358, it may be understood that any of the code blocks may be replaced with hardwired circuits, for example, built into an application specific integrated circuit (ASIC).

In an example, the instructions 1382 provided via the memory 1354, the storage 1358, or the processor 1352 may be embodied as a non-transitory, machine readable medium 1360 including code to direct the processor 1352 to perform electronic operations in the IoT device 1350. The processor 1352 may access the non-transitory, machine readable medium 1360 over the interconnect 1356. For instance, the non-transitory, machine readable medium 1360 may be embodied by devices described for the storage 1358 of FIG. 13 or may include specific storage units such as optical disks, flash drives, or any number of other hardware devices. The non-transitory, machine readable medium 1360 may include instructions to direct the processor 1352 to perform a specific sequence or flow of actions, for example, as described with respect to the flowchart(s) and block diagram(s) of operations and functionality depicted above.

In further examples, a machine-readable medium also includes any tangible medium that is capable of storing, encoding or carrying instructions for execution by a machine and that cause the machine to perform any one or more of the methodologies of the present disclosure or that is capable of storing, encoding or carrying data structures utilized by or associated with such instructions. A “machine-readable medium” thus may include, but is not limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks. The instructions embodied by a machine-readable medium may further be transmitted or received over a communications network using a transmission medium via a network interface device utilizing any one of a number of transfer protocols (e.g., HTTP).

It should be understood that the functional units or capabilities described in this specification may have been referred to or labeled as components or modules, in order to more particularly emphasize their implementation independence. Such components may be embodied by any number of software or hardware forms. For example, a component or module may be implemented as a hardware circuit comprising custom very-large-scale integration (VLSI) circuits or gate arrays, off-the-shelf semiconductors such as logic chips, transistors, or other discrete components. A component or module may also be implemented in programmable hardware devices such as field programmable gate arrays, programmable array logic, programmable logic devices, or the like. Components or modules may also be implemented in software for execution by various types of processors. An identified component or module of executable code may, for instance, comprise one or more physical or logical blocks of computer instructions, which may, for instance, be organized as an object, procedure, or function. Nevertheless, the executables of an identified component or module need not be physically located together, but may comprise disparate instructions stored in different locations which, when joined logically together, comprise the component or module and achieve the stated purpose for the component or module.

Indeed, a component or module of executable code may be a single instruction, or many instructions, and may even be distributed over several different code segments, among different programs, and across several memory devices or processing systems. In particular, some aspects of the described process (such as code rewriting and code analysis) may take place on a different processing system (e.g., in a computer in a data center), than that in which the code is deployed (e.g., in a computer embedded in a sensor or robot). Similarly, operational data may be identified and illustrated herein within components or modules, and may be embodied in any suitable form and organized within any suitable type of data structure. The operational data may be collected as a single data set, or may be distributed over different locations including over different storage devices, and may exist, at least partially, merely as electronic signals on a system or network. The components or modules may be passive or active, including agents operable to perform desired functions. Additional examples of the presently described method, system, and device embodiments include the following, non-limiting configurations. Each of the following non-limiting examples may stand on its own, or may be combined in any permutation or combination with any one or more of the other examples provided below or throughout the present disclosure.

Example 1 may be a system for managing cryptographic exchanges between devices capable of operating in accord with the Wireless Access Vehicular Environment (WAVE) functionality, comprising a device operable in at least a first environment in which the device is configured to: receive a first message with an associated first certificate chain; add a second certificate chain associated with the device to a second message; determine if the first certificate chain includes an unknown certificate, and if so, set a flag associated with the second message; determine if all certificates in the first certificate chain are known, and if so, check if message has the set flag, and if the flag is set, then unset the flag; and send the second message.

Example 2 may be example 1 in which a RSU is available to the device, but unavailable to a second device, the device further configured to facilitate communication between the second device and the RSU.

Example 3 may be any of examples 1-2 in which there may be a roadside unit (RSU) available to the device, further comprising the device configured to: determine if the RSU is available; if the RSU is unavailable, the device to operate in the first environment; and if the RSU is available, the device to operate in a second environment.

Example 4 may be example 3 further comprising the device operable in the second environment in which the device is configured to: receive the first message; determine if a signature verification for the first message requires an unknown certificate; if the unknown certificate is required, then listen to the RSU for a third message with a list including one or more certificates associated with the third message; and determine if the list provides the unknown certificate , and if so, update the certificate chain associated with the device.

Example 5 may be example 4 wherein the unknown certificate completes the certificate chain starting from the unknown certificate.

Example 6 may be example 4 further comprising the device configured to: determine the certificate list in the third message fails to provide and validate the unknown certificate, and request the unknown certificate from the RSU.

Example 7 may be example 6, further comprising the device configured to: attempt to verify the message with its updated certificate chain; and if unable to verify the message, report the message.

Example 8 may be any of examples 3-7 wherein the RSU is configured to: monitor devices in a neighborhood associated with the RSU; identify certificates used by devices in the neighborhood; and share certificates with the devices in the neighborhood with a frequency that is dynamically updateable based at least in part on a current distribution frequency and the monitor devices in the neighborhood.

Example 9 may be example 8, wherein the RSU is further configured to provide a wireless communication environment compliant with at least a portion of an IEEE 1609 specification.

Example 10 may be example 8, further comprising the RSU configured to exchange certificates with a PKI over a secure communication pathway.

Example 11 may be any of examples 8-10 wherein the frequency is also determined based at least in part on a trigger event.

Example 12 may be example 6, wherein the RSU is configured to: Identify the device as a new entering the neighborhood; and send the third message, which includes certificates in use in the neighborhood.

Example 13 mat be a method for managing cryptographic exchanges between devices capable of operating in accord with the Wireless Access Vehicular Environment (WAVE) functionality, including a device operable in at least a first environment in which the device is configured to: receive a first message with an associated first certificate chain; add a second certificate chain associated with the device to a second message; determine if the first certificate chain includes an unknown certificate, and if so, set a flag associated with the second message; determine if all certificates in the first certificate chain are known, and if so, check if message has the set flag, and if the flag is set, then unset the flag; and send the second message.

Example 14 may be example 13, in which there may be a roadside unit (RSU) available to the device, further comprising the device configured to: determine if the RSU is available; if the RSU is unavailable, the device to operate in the first environment; and if the RSU is available, the device to operate in a second environment.

Example 15 may be example 14, further comprising the device operable in the second environment in which the device is configured to: receive the first message; determine if a signature verification for the first message requires an unknown certificate; if the unknown certificate is required, then listen to the RSU for a third message with a list of one or more certificates associated with the third message; and determine if the list provides the unknown certificate, and if so, update the certificate chain associated with the device.

Example 16 may be example 15, further comprising the device configured to: determine the certificate list in the third message fails to provide and validate the unknown certificate, and request the unknown certificate from the RSU.

Example 17 may be example 16, further comprising the device configured to: attempt to verify the message with its updated certificate chain; and if unable to verify the message, report the message.

Example 18 may be any of examples 14-17 wherein the RSU is configured to: monitor devices in a neighborhood associated with the RSU; identify certificates used by devices in the neighborhood; and share certificates with the devices in the neighborhood with a frequency that is dynamically updateable based at least in part on a current distribution frequency and the monitor devices in the neighborhood.

Example 19 may be example 18 further comprising the RSU configured to exchange certificates with a PKI over a secure communication pathway.

Example 20 may be example 18 wherein the frequency is also determined based at least in part on a trigger event.

Example 21 may be example 17, wherein the RSU is configured to: Identify the device as a new entering the neighborhood; and send the third message, which includes certificates in use in the neighborhood.

Example 22 may be one or more non-transitory computer-readable media having instructions to provide for managing cryptographic exchanges with a device operable in at least a first and a second environment, and configure the device to: determine if a roadside unit (RSU) is available to the device, and if so, the device to operate in the first environment, and if not, to operate in a second environment; in the first environment, the device further to: receive a first message with an associated first certificate chain; add a second certificate chain associated with the device to a second message; determine if the first certificate chain includes an unknown certificate, and if so, set a flag associated with the second message; determine if all certificates in the first certificate chain are known, and if so, check if message has the set flag, and if the flag is set, then unset the flag; and send the second message.

Example 23 may be example 22, further having instructions for the device to operate in the second environment, and the device to be configured to: receive the first message; determine if a signature verification in the first message requires an unknown certificate; if the unknown certificate is required, then listen to the RSU for a third message with a list including one or more certificates associated with the third message; and determine if the list provides the unknown certificate and completes the certificate chain starting from the unknown certificate, and if so, update the certificate chain associated with the device.

Example 24 may be example 23, further having instructions for the device to be configured to: determine the certificate list in the third message fails to provide and validate the unknown certificate, and request the unknown certificate from the RSU; attempt to verify the message with its updated certificate chain; and if unable to verify the message, report the message.

Example 25 may be example 23, further having instructions for the device to be configured to communicate with a RSU configured to: monitor devices in a neighborhood associated with the RSU; identify certificates used by devices in the neighborhood; share certificates with the devices in the neighborhood with a frequency that is dynamically updateable based at least in part on a selected one or more of a current distribution frequency, the monitor devices in the neighborhood, or a trigger event; wherein the RSU is further configured to: exchange certificates with a PKI over a secure communication pathway; Identify the device as a new entering the neighborhood; and send the third message, which includes certificates in use in the neighborhood.

It will be apparent to those skilled in the art that various modifications and variations can be made in the disclosed embodiments of the disclosed device and associated methods without departing from the spirit or scope of the disclosure. Thus, it is intended that the present disclosure covers the modifications and variations of the embodiments disclosed above provided that the modifications and variations come within the scope of any claims and their equivalents.

What is claimed is:

1. A system for managing cryptographic exchanges between devices capable of operating in accord with the Wireless Access Vehicular Environment (WAVE) functionality, comprising a device operable in at least a first environment in which the device is configured to:
receive a first message with an associated first certificate chain;
add a second certificate chain associated with the device to a second message;
determine if the first certificate chain includes an unknown certificate, and if so, set a flag associated with the second message;
determine if all certificates in the first certificate chain are known, and if so, check if message has the set flag, and if the flag is set, then unset the flag; and
send the second message.

2. The system of claim 1 in which a RSU is available to the device, but unavailable to a second device, the device further configured to facilitate communication between the second device and the RSU.

3. The system of claim 1, in which there may be a roadside unit (RSU) available to the device, further comprising the device configured to:
determine if the RSU is available;
if the RSU is unavailable, the device to operate in the first environment; and
if the RSU is available, the device to operate in a second environment.

4. The system of claim 3, further comprising the device operable in the second environment in which the device is configured to:
receive the first message;
determine if a signature verification for the first message requires an unknown certificate;
if the unknown certificate is required, then listen to the RSU for a third message with a list including one or more certificates associated with the third message; and
determine if the list provides the unknown certificate, and if so, update the certificate chain associated with the device.

5. The system of claim 4 wherein the unknown certificate completes the certificate chain starting from the unknown certificate.

6. The system of claim 4, further comprising the device configured to:
determine the certificate list in the third message fails to provide and validate the unknown certificate, and request the unknown certificate from the RSU.

7. The system of claim 6, further comprising the device configured to:
attempt to verify the message with its updated certificate chain; and
if unable to verify the message, report the message.

8. The system of claim 3, wherein the RSU is configured to:
monitor devices in a neighborhood associated with the RSU;
identify certificates used by devices in the neighborhood; and
share certificates with the devices in the neighborhood with a frequency that is dynamically updateable based at least in part on a current distribution frequency and the monitor devices in the neighborhood.

9. The system of claim 8, wherein the RSU is further configured to provide a wireless communication environment compliant with at least a portion of an IEEE 1609 specification.

10. The system of claim 8, further comprising the RSU configured to exchange certificates with a PKI over a secure communication pathway.

11. The system of claim 8, wherein the frequency is also determined based at least in part on a trigger event.

12. The system of claim 4, wherein the RSU is configured to:
Identify the device as a new entering the neighborhood; and
send the third message, which includes certificates in use in the neighborhood.

13. A method for managing cryptographic exchanges between devices capable of operating in accord with the Wireless Access Vehicular Environment (WAVE) functionality, including a device operable in at least a first environment in which the device is configured to:
receive a first message with an associated first certificate chain;
add a second certificate chain associated with the device to a second message;
determine if the first certificate chain includes an unknown certificate, and if so, set a flag associated with the second message;
determine if all certificates in the first certificate chain are known, and if so, check if message has the set flag, and if the flag is set, then unset the flag; and
send the second message.

14. The method of claim 13, in which there may be a roadside unit (RSU) available to the device, further comprising the device configured to:
determine if the RSU is available;
if the RSU is unavailable, the device to operate in the first environment; and
if the RSU is available, the device to operate in a second environment.

15. The method of claim 14, further comprising the device operable in the second environment in which the device is configured to:
receive the first message;
determine if a signature verification for the first message requires an unknown certificate;
if the unknown certificate is required, then listen to the RSU for a third message with a list of one or more certificates associated with the third message; and
determine if the list provides the unknown certificate, and if so, update the certificate chain associated with the device.

16. The method of claim 15, further comprising the device configured to:
determine the certificate list in the third message fails to provide and validate the unknown certificate, and request the unknown certificate from the RSU.

17. The method of claim 16, further comprising the device configured to:
attempt to verify the message with its updated certificate chain; and
if unable to verify the message, report the message.

18. The system of claim 14, wherein the RSU is configured to:
monitor devices in a neighborhood associated with the RSU;
identify certificates used by devices in the neighborhood; and
share certificates with the devices in the neighborhood with a frequency that is dynamically updateable based at least in part on a current distribution frequency and the monitor devices in the neighborhood.

19. The method of claim 18, further comprising the RSU configured to exchange certificates with a PKI over a secure communication pathway.

20. The method of claim 18, wherein the frequency is also determined based at least in part on a trigger event.

21. The method of claim 15, wherein the RSU is configured to:
Identify the device as a new entering the neighborhood; and
send the third message, which includes certificates in use in the neighborhood.

22. One or more non-transitory computer-readable media having instructions to provide for managing cryptographic exchanges with a device operable in at least a first and a second environment, and configure the device to:
determine if a roadside unit (RSU) is available to the device, and if so, the device to operate in the first environment, and if not, to operate in a second environment;
in the first environment, the device further to:
receive a first message with an associated first certificate chain;
add a second certificate chain associated with the device to a second message;
determine if the first certificate chain includes an unknown certificate, and if so, set a flag associated with the second message;
determine if all certificates in the first certificate chain are known, and if so, check if message has the set flag, and if the flag is set, then unset the flag; and
send the second message.

23. The media of claim 22, further having instructions for the device to operate in the second environment, and the device to be configured to:
receive the first message;
determine if a signature verification in the first message requires an unknown certificate;
if the unknown certificate is required, then listen to the RSU for a third message with a list including one or more certificates associated with the third message; and
determine if the list provides the unknown certificate and completes the certificate chain starting from the unknown certificate, and if so, update the certificate chain associated with the device.

24. The media of claim 23, further having instructions for the device to be configured to:
determine the certificate list in the third message fails to provide and validate the unknown certificate, and request the unknown certificate from the RSU;
attempt to verify the message with its updated certificate chain; and
if unable to verify the message, report the message.

25. The media of claim 23, further having instructions for the device to be configured to communicate with a RSU configured to:
monitor devices in a neighborhood associated with the RSU;
identify certificates used by devices in the neighborhood;
share certificates with the devices in the neighborhood with a frequency that is dynamically updateable based at least in part on a selected one or more of a current distribution frequency, the monitor devices in the neighborhood, or a trigger event;
wherein the RSU is further configured to:
exchange certificates with a PKI over a secure communication pathway;
Identify the device as a new entering the neighborhood; and
send the third message, which includes certificates in use in the neighborhood.
